(19) United States
(12) Patent Application Publication
(10) Pub. No.: US 2025/0360973 A1
(43) Pub. Date: Nov. 27, 2025

(54) FLYWHEEL AND STEERING-BASED VEHICLE DYNAMICS ENHANCEMENT METHODS

(71) Applicant: Daniel PILON, Lasalle (CA)

(72) Inventor: Daniel PILON, Lasalle (CA)

(21) Appl. No.: 18/874,963

(22) PCT Filed: Jun. 15, 2023
(86) PCT No.: PCT/CA2023/050832

§ 371 Date: Dec. 13, 2024

(30) Foreign Application Priority Data
Jun. 15, 2022 (GB) 2208834.8
Jun. 16, 2022 (GB) 2208835.5
Jul. 8, 2022 (CA) 3167709

(51) Int. Cl. B62D 37/04; B62H 7/00; B62K 5/10

(52) U.S. Cl. CPC B62D 37/04; B62H 7/00; B62K 5/10

(57) ABSTRACT

Narrow vehicles have multiple advantages but tend to have a limited application because they are roll unstable. The use of flywheels to increase their stability is a known method but the operation range, complexity, performance and cost usually limit the application of these vehicles. Stability and agility enhancement system and method enabling the application of stabilizing forces from flywheels and the steering of the trajectory concurrently and cooperatively with the driver's steering and assistance enable the benefit of reduced cost and complexity while providing enhanced performances, intuitive control, safety and operation range.

### CROSS-REFERENCES TO OTHER RELATED PATENT APPLICATIONS

This application claims priority from the UK patent application 2208834.8 filed Jun. 15, 2022, the UK patent application 2208835.5 filed Jun. 16, 2022, and the Canadian patent application 3,167,709 filed Jul. 8, 2022, the content of which are hereby incorporated by reference.

### FIELD OF THE INVENTION

The present invention relates to the general field of stabilizing method particularly adapted to enhance the stability, the agility and the control of a tilting/roll-unstable system such as motorcycles, narrow track vehicles and robots.

### BACKGROUND OF THE INVENTION

Non-tilting vehicles usually have their stability and cargo capacity limited by the maximum lateral force they can withstand without being at risk of getting in an undesirable rollover or other handling difficulties. This limit is a known problem of narrow track vehicles, all-terrain vehicles, trucks and other types of vehicles. It limits their adoption, maximum speed, agility, safety and cargo-carrying capacity. It also limits the comfort, the handling of cargo and of passengers with the vehicle.

Roll bar, tilting mechanism, low center of gravity, steering system, suspension system and other solutions have been developed to reduce the negative impact of lateral forces on the vehicle dynamics but room for improvement justifies search for new solutions. One example is the need for narrow vehicles to reduce and mitigate the significant environmental impact of larger vehicles.

In a typical tilting vehicle like a bicycle or motorcycle in motion, the trajectory and the balance of the vehicle are controlled at least in part with the steering of the vehicle. This is usually at least in part achieved with the use of steering and countersteering to initiate a turn or tilt to compensate for the centrifugal forces or other external forces.

The steering method intuitively applied by most users to steer this type of vehicle traveling at a forward speed in its stable range is to apply a steering torque in a direction opposite to the desired trajectory and to remove the steering torque to return the trajectory to a straight line. The countersteering is usually at least in part produced automatically by the weight distribution and the steering geometry of the typical assembly composed of the vehicle and its driver. This being said, a typical assembly enables the driver to control the trajectory and the balance but have many know problems associated with their limited stability.

These vehicles are known to have limited stability and issues like a limited speed range of stable operation and a limited ability to compensate for an external force or a lost of traction. The requirement to lean before to steer in a direction is known and the time required to initiate a lean before turning is sometimes a problem. Many problems of oscillation like headshakes, speed wobbles and steering kickbacks are also known. Stability control systems for improving the road stability and agility of wheeled vehicles exist. In some instances, known stability control systems include one or more rotating gyroscope assemblies mounted in the wheels or in the chassis of the vehicles.

Rotating gyroscopes may impact positively the dynamic stability of the wheeled vehicle in which they are mounted. For more than 100 years, people tried to integrate gyroscopes in two wheeled vehicles to increase their stability but with limited success.

While these known stability control systems can in some conditions provide some level of improved stability to a wheeled vehicle, they generally offer limited performance and safety and added complexity and cost. They also had, in some conditions, oscillation problem, negative feedback and a negative impact on the driver's control of the balance and steering of the trajectory.

Thus, there is a need on the market for an improved flywheel-based stability control method that is significantly more efficient, intuitive and reliable at providing stability, agility and control.

### SUMMARY OF THE INVENTION

In a broad aspect, a proposed steering enhancement method is useful for improving the stability, agility and control of tilting vehicles, such as two or more wheels bicycles, motorcycles, tilting cars and some all-terrain vehicles (ATV).

Also, a proposed inertial compensation method is useful for improving the stability, agility and control of roll unstable vehicles is presented.

The inertial compensation method and the steering enhancement method may also be integrated together in a tilting vehicle to produce a synergistic effect in a method called the dynamics enhancements methods.

The applicant proposes a steering enhancement apparatus connectable to a tilting vehicle to provide improved steering and stability, the steering enhancement apparatus comprising: a steering controller comprising: at least one driver input for receiving a driver's steering command; at least one tilt angle error sensor; a stability enhancement controller for determining a stability enhancement steering command to reduce a tilt angle error determined based on signals of the at least one tilt angle error sensor; at least one steering actuator connectable to a trajectory controller of the tilting vehicle for the application of an actuator steering force on the trajectory controller based on a position steering controller's assistance command; and wherein the position steering controller's assistance command is determined based at least on the received the driver's steering command and on the stability enhancement steering command; at least one flywheel assembly comprising: a flywheel rotating mass spinning when the steering enhancement apparatus is in operation; and a motor for providing part of a total angular momentum of the flywheel by spinning the at least one flywheel; at least one of: a coupling interface for mounting the at least one flywheel assembly onto the trajectory controller so that steering of the trajectory controller to a first steered position simultaneously steers the at least one flywheel assembly to the first steered position; and at least one steering linkage connectable to the trajectory controller and connected to at least one flywheel gimbal assembly so that the steering of the trajectory controller to the first steered position simultaneously steers the at least one flywheel gimbal assembly to a corresponding second steered position following a predetermined steering ratio, wherein the at least one flywheel's gimbal comprises: at least one gimbal's axis pivotally connectable to a tilting assembly of the the tilting vehicle to be substantially perpendicular to a longitudinal axis of the tilting assembly, and wherein an axis of rotation of the at least one flywheel assembly is pivotally connected substantially perpendicularly to the gimbal's axis, wherein, when the steering enhancement apparatus is connected to the tilting vehicle, the steering of the trajectory controller of the tilting vehicle applies a precession roll torque from the at least one flywheel assembly at least in part toward a right side of the tilting vehicle when the steering rate is toward a left side of the tilting vehicle and a precession roll torque at least in part toward the left side when the steering rate is toward the right side.

In some embodiments, the driver's steering command is provided from at least one of: a steering force sensor measuring a driver's steering force applied by the driver to steer the tilting vehicle; and an autonomous driving system generating the driver's steering command.

In some embodiments, the driver's steering command is provided from at least one of: a transmitter transmitting the driver's steering command detected by a driver interface and generated by the driver; and an autonomous driving system generating the driver's steering command.

In some embodiments, the steering linkage is a mechanical steering linkage.

In some embodiments, the at least one steering actuator at least comprises a first steering actuator for steering the trajectory controller to the first steered position and a second steering actuator for steering the at least one flywheel's gimbal to the second steered position, wherein the first and second steering actuator acts as the steering linkage to interconnect the first steered position and the second steered position following the predetermined steering ratio.

In some embodiments, the first steered position and the second steered position is the orientation of the one or more flywheel assembly is substantially centered when the tilting vehicle initiates a forward motion.

In some embodiments, the steering controller further comprises a steering position sensor for measuring a steering position, wherein the steering controller further determines a centering assistance command to steer away from a centered position based on a measured the steering position and further considers the centering assistance to determine the steering controller's assistance command.

In some embodiments, the steering controller add a traction assistance to the steering controller's assistance command based on a lateral slippage estimation.

In some embodiments, the steering controller determines a steering damper assistance reducing a speed and acceleration of the steering actuator as a speed of the tilting vehicle increases.

In some embodiments, the steering controller determines a linearization gain based at least in part the speed of the tilting vehicle, a total angular momentum in a backward direction of the flywheel rotating mass, an angular momentum in the steered flywheels assembly and a position of the steered assembly.

In some embodiments, the d tilting vehicle is operable as a torque controlled trajectory steering in the direction opposite to the applied torque and wherein the trajectory controller provides a position feedback to the driver.

In some embodiments, the steering controller mechanically transmits the driver's steering force to the trajectory controller through the steering actuator to provide a mechanical path enabling the driver to steer the vehicle in case of failure.

In some embodiments, the connectable steering enhancement apparatus is a steering enhancement kit connectable to the tilting vehicle.

In some embodiments, the steering enhancement kit is connectable to a steering

In some embodiments, the autonomous driving system comprises a collision avoidance function used to determine the driver's steering command based on proximity data provided from at least one proximity sensor.

In some embodiments, the at least one driver input receives the driver's steering command from the autonomous driving system and one of the steering force sensor and the transmitter, wherein the steering controller determines the steering controller's assistance command based on one of the received driver's steering commands.

In some embodiments, the steering controller determines the steering controller's assistance command based on a prioritized one of the received driver's steering commands following a priority rule.

In some embodiments, the priority rule prioritize the driver's steering command from the autonomous driving system.

In some embodiments, the steering force sensor is connectable to a manually operated steering input through a flexible steering input providing flexibility between the manually operated steering input and the steering input.

In some embodiments, a flexibility of the flexible steering input is manually adjusted.

In some embodiments, the flexibility of the flexible steering input is automatically adjusted based at least in part on the speed of the tilting vehicle.

In some embodiments, transmitter is a manually operated steering input is a remote manually operated steering input electronically sending the manual driver's steering command to the steering input of the steering controller, wherein the steering controller further determines the feedback command at least based on at least one of the first steered position and the second steered position; and electronically sends the feedback command to the manually operated steering input.

In some embodiments, the steering controller is connectable to a vehicle speed sensor for measuring the speed of the tilting vehicle.

In some embodiments, the steering controller further comprises a control interface allowing a user to selectively adjust a degree of stabilization assistance provided by the controller.

In some embodiments, the control interface can be used to limit the steering controller assistance command to be based on only one of the manual driver's steering command and the stability enhancement steering command.

In some embodiments, the steering controller further considers the speed of the tilting vehicle to determine the steering controller assistance command.

In some embodiments, the steering linkage further comprises a steering ratio adjusting component for adjusting the predetermined steering ratio.

In some embodiments, the steering ratio adjusting component comprises a steering ratio actuator for automatically adjusting the predetermined steering ratio following a ratio adjustment command.

In some embodiments, the controller further considers a speed, a weight and an angular momentum of the at least one flywheel to determine the steering controller assistance command.

In some embodiments, the steering controller further comprises at least one flywheel speed sensor for measuring the speed of the flywheel of the at least one flywheel assembly, wherein the controller further considers the speed to determine the steering controller assistance command.

In some embodiments, the proposed apparatus further comprises a pendulum connectable to the tilting assembly of the tilting vehicle, and wherein the at least one tilt angle error sensor comprises an angle sensor for measuring the angle between the pendulum and the tilting assembly.

In some embodiments, the at least one tilt angle error sensor comprises a lateral acceleration sensor for measuring at least one lateral force on the tilting vehicle and a roll rate sensor for measuring a roll acceleration of the tilting vehicle, wherein the tilt angle error is determined based on the at least one measured lateral force and the roll acceleration.

In some embodiments, the steering controller determines the steering controller assistance command further based on a centering assistance for centering the trajectory controller around a desired trajectory.

In some embodiments, the steering controller is connectable to a drive train assembly of the tilting vehicle, wherein the steering controller further determines a drive train control command for driving the drive train to apply a drive force for displacing a contact point of the trajectory controller relatively to a support surface of the tilting vehicle, when the first steered position is off centered, so that the drive train assembly applies a roll torque on a center of mass of the tilting vehicle according to the drive command; and wherein the drive train control command is determined based on the tilt angle error and an orientation of the first steered position.

In some embodiments, the steering enhancement apparatus when connected to the tilting vehicle is steerable as a torque controlled trajectory controller by applying a torque controlled steering in a direction opposed to a manual torque by the driver.

In some embodiments, the steering controller determines a steering damper assistance reducing a speed and an acceleration of the steering actuator as a speed of the tilting vehicle increases.

In some embodiments, energy is stored as kinetic energy by increasing the speed of the flywheel of the at least one flywheel assembly using the motor of the at least one flywheel assembly.

In some embodiments, the proposed apparatus further comprises a propulsion motor for propelling the tilting vehicle, wherein part of a kinetic energy of the tilting vehicle is captured by the propulsion motor and transferred as electric current to the motor of the at least one flywheel assembly to be stored as the stored kinetic energy, and wherein the stored kinetic energy is captured by the motor of the at least one flywheel assembly and transferred as the electric current to the propulsion motor for propelling the tilting vehicle.

In some embodiments, the tilting vehicle further comprises a battery, and wherein the electric current is exchanged with the battery.

In some embodiments, the at least one flywheel gimbal assembly comprises a first flywheel gimbal assembly and a second flywheel gimbal assembly, wherein the flywheel of the first flywheel gimbal assembly spins frontward and the flywheel of the second flywheel gimbal assembly spins backward, and wherein a total angular momentum of the flywheel of the first and the second flywheel gimbal assembly ensures that the roll torque applied on the tilting assembly is oriented substantially toward the right side of the tilting assembly when the trajectory of the tilting vehicle is changing leftwardly and is oriented substantially toward the left side of the tilting assembly when the trajectory is changing rightwardly.

In some embodiments, the motor of the second flywheel gimbal assembly adjust the speed of the flywheel of the second flywheel gimbal assembly for increasing an angular momentum of the flywheel of the second flywheel gimbal assembly when the speed of the tilting vehicle increases and for reducing the angular momentum of the flywheel of the second flywheel gimbal assembly when the speed of the tilting vehicle decreases.

In some embodiments, the stored kinetic energy is stored in the flywheel of the second flywheel gimbal assembly as the angular momentum.

In some embodiments, the flywheel spinning mass of the flywheel is connected to the motor through a flexible flywheel linkage for reducing a transfer of vibrations between the flywheel mass and the motor.

In some embodiments, resonant frequency the flexible flywheel linkage is below a resonant frequency of the flywheel spinning mass in operation.

In some embodiments, the flywheel assembly is coaxially mounted inside the trajectory controller.

In some embodiments, the tilting vehicle is a tilting wheeled vehicle and the trajectory controller is at least one steered wheel.

The applicant further proposes a tilting vehicle having an improved steering and stability, the tilting vehicle comprising: a tilting assembly; a steering assembly comprising: at least one flywheel gimbal assembly comprising: at least one flywheel assembly comprising: a flywheel spinning when the tilting vehicle is in operation; wherein the flywheel has a total angular momentum that ensures that a roll torque applied on the tilting assembly is oriented substantially toward a right side of the tilting assembly when a trajectory of the tilting vehicle is changing leftwardly and is oriented substantially toward a left side of the tilting assembly when the trajectory is changing rightwardly; and a motor for providing part of the total angular momentum by spinning the at least one flywheel; and at least one flywheel gimbal comprising: at least one gimbal axis for steering the flywheel and pivotally attached to the the tilting assembly to be substantially perpendicular to a longitudinal axis of the tilting assembly; and at least one flywheel assembly with its axis of rotation pivotally connected substantially perpendicularly to the the gimbal's axis; at least one surface engaging steering member connected to the tilting vehicle for supporting and controlling the trajectory; wherein an axis of rotation of the at least one flywheel assembly is normally oriented for providing a precession torque to the tilting assembly when the at least one flywheel gimbal is steered and for providing a steering torque to the at least one flywheel gimbal when a torque is applied to the tilting assembly; wherein the steering assembly is steerable as a torque controlled trajectory controller; and a manually operated steering input for receiving a manual driver's steering force, for generating a manual driver's steering command according to the manual driver's steering force, and applying a position feedback force in a direction opposite to the manual driver's steering force according to a received feedback command; and a steering controller comprising: a steering input for receiving a manual driver's steering command; at least one tilt angle error sensor; a stability enhancement controller for determining a stability enhancement steering command required to reduce a tilt angle error determined based on signals of the at least one tilt angle error sensor; at least one steering actuator for generating an actuator steering force on the steering assembly for steering the flywheel gimbal and the surface engaging steering member according to a steering controller assistance command; and wherein the steering controller assistance command is determined at least based on the manual driver's steering command and the stability enhancement steering command.

In some embodiments, the manually operated steering input is coupled to said at least one surface engaging steering member, wherein said manual driver's steering command is a mechanical force transferred to said steering input of said steering controller, and wherein said feedback command transfers, to said manually operated steering input, forces applied on said steering assembly when said tilting vehicle is in operation.

The applicant further proposes a method of operation comprising the steps of: 1) reading the at least one sensor of the sensor arrangement; 2) determining a centrifugal force compensation of the vehicle; 3) determining a stability enhancement of the vehicle; 4) determining a steering dampening level; 5) determining a steering ratio; 6) determining a steering liberalization response; 7) determining the self centering force to apply on the steering assembly; and 8) controlling accordingly and concurrently at least the rotational speed, or rpm, of the flywheel of at least one gyroscope assembly, and the power steering actuator. Different embodiments integrating at least one of these two methods are presented in detail in this document. Also, a method for operating of the proposed embodiment is provided.

Many additional features combined in an innovative way are in the descriptions and also constitute innovation.

### BRIEF DESCRIPTION OF THE DRAWINGS

FIG. 1 shows a front perspective view illustrating an embodiment of a bicycle that may be used to apply the steering enhancement method, the inertial compensation method or the two methods in combination as the dynamics enhancements methods;

FIG. 2 shows a front perspective view illustrating an embodiment of the bicycle of FIG. 1, here showing an exploded view of the front and rear wheels including a flywheel assembly in the front wheel that may be used to apply the steering enhancement method;

FIG. 3 shows a front perspective view illustrating one embodiment of the bicycle of FIG. 1, here showing an exploded view of the front and rear wheels including a flywheel assembly in the rear wheel that may be used to apply the inertial compensation method;

FIG. 4 shows a front perspective view illustrating one embodiment of the bicycle of FIG. 1, here showing an exploded view of the front and rear wheels including a flywheel assembly in both the front and the rear wheel that may be used to apply the steering enhancement method, the inertial compensation method or the two methods in combination as the dynamics enhancements methods;

FIG. 5 shows a perspective exploded view illustrating one embodiment of the flywheel assembly;

FIG. 6 shows a partial rear perspective view illustrating an embodiment of a stabilizing control system, here comprising a steering motor mounted on the front end of the bicycle chassis;

FIG. 7 is a diagram of the elements of the stability enhancement method that may be used in one embodiment of the disclosure;

FIG. 8 shows a front perspective view illustrating an embodiment of a stabilizing control system, according to the present invention, here shown including two gyroscope assemblies mounted in the chassis of a motorcycle;

FIG. 9 shows a side perspective view illustrating the stabilizing control system of the embodiment of FIG. 8, here shown when the manually operated steering input of the motorcycle is oriented straight forwardly. The flywheel assembly mounted in the chassis is shown operatively connected to the steering assembly and the steering motor of the motorcycle through a steering linkage arrangement;

FIG. 10 illustrates the stabilizing control system of the embodiment of FIG. 8, here shown when the manually operated steering input of the motorcycle is oriented rightwardly;

FIG. 11 illustrates the stabilizing control system of the embodiment of FIG. 8, here shown when the manually operated steering input of the motorcycle is oriented leftwardly;

FIG. 12 shows an enlarged side partial view illustrating a possible embodiment of the stabilizing control system of the embodiment of FIG. 8, here shown with the gimbal's ratio actuator fixing a neutral gimbal's ratio adjustment.

FIG. 13 shows an enlarged side partial view illustrating a possible embodiment of the stabilizing control system of the embodiment of FIG. 8, here shown with the gimbal's ratio actuator fixing a positive gimbal's ratio adjustment.

FIG. 14 shows a side perspective view illustrating an embodiment with a system to apply the dynamics enhancement methods, including multiple steering motor as the steering actuator and as the steering linkage to steer the flywheel's gimbal mounted in the chassis of a motorcycle, the manually operated steering input and the steered wheels.

FIG. 15 shows a front perspective view illustrating an embodiment of a system according to the present invention mounted on a three-wheel motorcycle provided with a side-tilting rear axle, and with the manually operated steering input oriented straight forwardly. The three-wheel motorcycle includes a flywheel assembly in the front wheel spinning forward (i.e., spinning in the same direction than the direction of the wheel when the vehicle travels forward), one flywheel assembly in each rear wheel spinning backward and one steering controller mounted on the front end of the motorcycle chassis;

FIG. 16 shows a rear view of the embodiment of the three-wheel motorcycle of FIG. 15 in an upright (non-tilted) position;

FIG. 17 illustrates the stabilizing control system of the embodiment of FIG. 15, here showing the three-wheel motorcycle having its manually operated steering input oriented rightwardly and the motorcycle chassis tilted sidewardly to the right;

FIG. 18 shows a rear elevational view illustrating the embodiment of the three-wheel motorcycle of FIG. 15 tilted sidewardly to the right;

FIG. 19 illustrates the stabilizing control system of FIG. 15, here showing the three-wheel motorcycle having its manually operated steering input oriented leftwardly and the motorcycle chassis tilted sidewardly to the left;

FIG. 20 shows a rear elevational view illustrating the embodiment of the three-wheel motorcycle of FIG. 15 tilted sidewardly to the left;

FIG. 21 shows a partial side view illustrating the manually operated steering input of the three-wheel motorcycle of FIG. 15 oriented straight forwardly and operatively connected to the vehicle steering assembly and power steering actuator of the motorcycle through an elongated steering extension link adjusted with a steering ratio of 1;

FIG. 22 illustrates the manually operated steering input of the three-wheel motorcycle of FIG. 15, here shown when with the manually operated steering input are oriented rightwardly;

FIG. 23 illustrates the manually operated steering input of the three-wheel motorcycle of FIG. 15, here shown when the manually operated steering input is oriented leftwardly;

### DETAILED DESCRIPTION

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

From the foregoing it will be appreciated that, although specific embodiments have been described herein for purposes of illustration, various modifications may be made without deviating from the spirit and scope of the teachings. Accordingly, the claims are not limited by the disclosed embodiments.

The embodiments are in such detail as to clearly communicate the disclosure without limiting the anticipated variations of the possible embodiments and may encompass all modifications, equivalents, combinations and alternatives falling within the spirit and scope of the present disclosure. It will be appreciated by those skilled in the art that well-known methods, procedures, physical processes, components and structures may not have been described in detail in the following so as not to obscure the specific details of the disclosed invention.

It will be appreciated that some of the embodiments described herein can allow a simple integration of added forces (i.e., using at least one flywheel) for enhancing the tilting vehicle's dynamic and/or static stability by means of providing assisted steering to the driver and/or providing automated stability control to the tilting vehicle.

Compared with many known state-of-the-art systems using flywheels and gyroscopes to modify the stability, the proposed method and apparatus may be steered intuitively as a torque controlled trajectory (e.g.; similar to a motorcycle in its stable speed range).

The proposed method may also provide redundancy to the steering system with the use the driver (e.g. steering as a torque controlled trajectory) and the flywheels (e.g. steering the vehicle to increase the stability) if the steering actuator fail while the vehicle travel forward.

The proposed method may also be integrated or added to the driver's steering (e.g., integrated within the driver's steering during its production or as an add-on to an existing driver's steering).

The proposed method may also provide a simplified control and a reduced part count compared to many systems using flywheels and/or gyroscopes to increase the stability.

Compared to most systems not using the precession from flywheels to balance the vehicle, the proposed method may enable an increased assistance in low speed and reduced traction conditions.

The proposed method may be used to extend the range of applications of vehicles. For example, it may enable the use of a roof and door for an improved comfort and/or aerodynamic. It may also be used to increase the safe cornering speed and road conditions.

The proposed method may be used to limit the possibly catastrophic oscillation mode of tilting vehicles and ensure the collaborative steering of the system's components. For example, by preventing possible negative feedback between various components, which can be achieved in some embodiments by ensuring that various components (e.g., interdependent components) of the proposed system are simultaneously controlled (e.g., steered).

The proposed method may be used to enhance the balance or the steering of vehicles on the water, on the snow and moving at low speed or reverse.

The proposed method can facilitate the adoption of a tilting vehicle by a rider (e.g., a learning driver) since it may provide an intuitive steering, which can be similar to the steering of a regular bicycle or motorcycle traveling forward in its stable speed range.

An important aspect of some embodiments lies in configurations that can ensure that the driver can safely keep control of the steering of the tilting vehicle when an electric, electronic and/or electromechanical component of the apparatus or the apparatus itself fails (e.g., when a failure of the steering controller 850 occurs). For example, the flywheel assembly 100 may be safely recovered/steered by the driver using the same control mode to balance and steer the vehicle (e.g., as a torque controlled trajectory with a position feedback) but with an increased steering torque.

It is to be noted that use of the present invention may not be limited to any type of suitable tilting vehicle and can be suitably sized and configured so as to be implemented in small or toy models of various wheeled vehicles, and/or in remotely controlled and autonomous embodiments.

It is easy to imagine the proposed method used in small and efficient autonomous delivery vehicles or personal transportation systems.

Although the present invention has been described with embodiments thereof, it can be modified, without departing from the spirit and nature of the subject's means and methods.

### The Steering Enhancement Method

The steering enhancement method may contain a tilting vehicle 500, a steering controller 850, a steering assembly 815, a driver 855 and/or a stability enhancement controller 809.

The steering enhancement method is used to enhance the control of the stability and the agility of the vehicle. This may improve the user experience and functionalities. The added stability may enable the driver to stop without to put a foot on the ground, to skid without falling, to take turns with more agility and to absorb the impact without falling.

The steering enhancement method interconnect and operate the components in a new method of enhancing the individual ability of each one to control the trajectory, the stability and the comfort of the vehicle.

The steering enhancement method may use a control scheme where the steering controller 850, the driver 855 the flywheel's gimbal 112 and, in some embodiments, the stability enhancement controller 809 concurrently and cooperatively steer the steering assembly 815. This interconnection creates a new and unexpected result since it allows the driver 855 to steer and countersteer the steering assembly 815 in cooperation with the steering from flywheel's gimbal 112, from the steering controller 850 and from the stability enhancement controller 809. The ability of the driver 855 to steer contribute to an increased safety since it enables the driver 855 to control the stability and the trajectory with an intuitive driver's steering command 898 even if the stability enhancement controller 809 or the steering controller 850 fail. This method may also increase the driver's stability and agility at low speed.

The various components used in the steering enhancement method also contains innovations in the way they operate and are integrated in the vehicle.

### The Tilting Vehicle

The tilting vehicle 500 is a vehicle with a tilting assembly tilting in the roll axis to enhance the stability, the agility or the user experience of the tilting vehicle 500. A regular bicycle or motorcycle may provide a suitable tilting vehicle 500 for the application of the steering enhancement method since the whole vehicle is the tilting assembly in the case of these single-track vehicles and the steering geometry is designed to be stable when traveling forward. This mean the steering axis angle, the rake, the trail and the fork offset of the trajectory controller 705 are designed to apply a steering torque increasing the vehicle stability with the appropriate centrifugal forces compensating at least in part for the gravitational forces when operated in its stable speed range.

A typical three or more wheeled vehicle with a tilting assembly tilting in the roll axis to enhance its stability, agility or user experience may also provide a suitable tilting vehicle 500 for the application steering enhancement method.

An already existing tilting vehicle 500 may be modified and equipped with a system providing a suitable steering assembly 815, driver 855, steering controller 850 and stability enhancement controller 809 for the application of the steering enhancement method. The components required for the use of the steering enhancement method may be provided as a kit compatible and ready to install on already existing tilting vehicle 500 such as bicycle and motorcycle.

The tilting vehicle 500 may be a vehicle designed and produced with all the components required to use the steering enhancement method.

The tilting vehicle 500 may be a vehicle powered by a thermal, an electrical or a hybrid drive train motor.

### The Driver

The driver 855 may steer the steering assembly 815 to control the trajectory and the stability of the vehicle. The driver 855 may be an occupant of the vehicle, a remote user of the vehicle, an autonomous driving system or a combination of these. The driver 855 may transmit a driver's steering command 898 to the steering controller 850 to steer the steering assembly 815.

The driver 855 may apply a driver's steering torque 857, transmit a signal corresponding to a driver's steering command 898 or a combination of both to the steering controller 850 to steer the steering assembly 815.

An embodiment may combine two types of driver 855 and may combine two types of driver's steering command 898. An embodiment may receive driver's steering command 898 from a human steering the vehicle with a driver's steering torque 857 manually applied and driver's steering command 898 from an autonomous driving system if an imminent collision is detected (e.g. precise collision avoidance system). It will be appreciated that, in an embodiment where both a driver's steering command can be received from both a driver and autonomous driving system (e.g., artificial intelligence system), the steering controller may prioritize one of the driver's steering commands according to priority rules. For example, the priority rules may favor/prioritize a driver's steering command originating from the autonomous system when it is an alert or emergency command (e.g., when a danger/obstacle is detected or when significant shock is detected or when the vehicle is slipping).

In one embodiment, the driver's steering command 898 from the driver 855 may be the driver's steering torque 857 manually applied on a manually operated steering input 522. The driver 855 may steer the steering controller 850 with driver's steering command 898 similar to the driver's steering command 898 used by typical driver of typical motorcycles to control the trajectory and the balance of two wheeled vehicles traveling at a forward speed in its stable range.

One embodiment may allow the driver 855 to balance the vehicle with the driver's steering command 898 similar to the one used at higher speeds on regular motorcycles even if the vehicle travel at low speed or standstill. It is usually difficult to balance at very low-speed a typical single-track vehicle not equipped with the proposed steering enhancement method since a forward speed is normally required to apply the roll torque necessary to balance these vehicles. The steering enhancement method may enable the driver 855 with the ability to steer the vehicle to apply a roll torque required to balance it even at low speed or standstill.

One embodiment using the steering enhancement method in a vehicle traveling at a forward speed in its stable range may be manually steered by the driver 855 by applying a steering torque in the direction opposite to the desired trajectory. Thereby, the driver 855 may operate the system as a torque-controlled system steering in the direction opposite to the applied torque and with a delay following the application of the steering torque.

In one embodiment, the driver 855, may be a human driver manually operating a regular motorcycle's manually operated steering input 522 to steer the trajectory of the vehicle by applying a steering torque in the direction opposite to the desired trajectory and roughly proportional to the desired steering angle.

The driver 855 may also be a human driver using a remote controller to send a signal to the steering controller 850 corresponding to the driver's steering command 898 to control the trajectory of the vehicle. This may enable, the driver 855 to steer the trajectory as a torque controlled steering angle.

The driver 855 using the steering enhancement method may be an autonomous driving system sending signals to the steering controller 850 corresponding to the steering torque to apply to the steering assembly 815 to control the trajectory and at least in part the balance of the tilting vehicle (e.g., a two wheeled vehicle). Therefore, the autonomous driving system may steer the trajectory as a torque controlled steering angle.

In one embodiment using the steering enhancement method, the driver 855 may receive position feedback, force feedback, signal feedback or a combination of these from the steering controller 850 enabling it to sense at least in part the state of the steering assembly 815.

In one embodiment, the driver 855 may be a human driver manually steering a manually operated steering input 522 and manually feeling the reaction torque and the position of the manually operated steering input 522. This can provide the driver 850 with means to sense the state of the steering controller 850 and the steering assembly 815. This feedback from the steering assembly 815 may increase the ability of the driver 855 to manage the use of the limited precession torque in the roll axis available to stabilize the vehicle.

### The Stability Enhancement Controller

The stability enhancement controller may 809 steer the steering assembly 815 to increase the stability of the tilting assembly.

The stability enhancement controller 809 may transmit a stability enhancement steering 810 as a mechanical force, a signal or a combination of both to the steering controller 850 to steer the steering assembly 815.

The stability enhancement controller 809 may determine the stability enhancement steering 810 based on signals received from tilt angle error sensors.

The stability enhancement controller 809 may determine its stability enhancement steering 809 with tilt angle error sensor (e.g., accelerometer angular rate sensor) and processors shared or integrated in the steering controller 850.

In one embodiment, the stability enhancement controller 809 may determine the stability enhancement steering 810 based on an estimated the tilt angle error 885.

In one embodiment, the stability enhancement controller 809 may determine the tilt angle error 885 as the difference between the estimated angle where no lateral forces are applied on the tilting assembly 885 and the actual tilt angle of the tilting assembly 885.

In an embodiment, the tilt angle error 885 may be estimated from the gravity, the centrifugal force and the other forces sensed on the lateral axis of the tilting assembly. In the case of the vehicle taking a turn with a balanced tilt angle of the tilting assembly, the gravity and centrifugal forces may mostly cancel one another in the lateral axis and the tilt angle error 885 estimated may be around zero. Furthermore, in the case of the vehicle going in a straight line on a flat ground and with a vertical angle of the tilting assembly, the gravity may be perpendicular to the lateral axis and the tilt angle error 885 estimated may be around zero.

In an embodiment, the lateral forces on the tilting assembly may be estimated from the signal of a lateral acceleration sensor 805 and a roll acceleration calculated from a roll rate sensor 806 used as the tilt angle sensor. These two sensors may be attached to the tilting assembly 885. The lateral forces generated by the roll acceleration may be removed to the measured lateral force to determine the tilt angle error 885. The lateral acceleration sensor 805 and the roll rate sensor 806 may be provided by a typical micro-electro-mechanical systems (MEMS) accelerometer sensor and MEMS gyroscope sensor.

In another embodiment, the tilt angle error 885 may be estimated with a pendulum having its axis of rotation pivotally connected to the tilting assembly 885 and oriented in the roll axis of the tilting assembly 885. An angle sensor measuring the angle between the pendulum and the tilting assembly 885 may provide an appropriate tilt angle error sensor to determine the tilt angle error 885. The distance between the center of mass and the axis of rotation of the pendulum may also be adjusted to improve the estimation of the tilt angle error 885. Spring and stopper limiting the angular range of motion of the pendulum may also be used to tune the sensor behavior.

In another embodiment, the tilt angle error 885 may be estimated by measuring the lateral forces applied on the tilting assembly by the flywheel assembly 100 used as a tilt angle error sensor. The precession forces from the flywheel assembly 100 produced by the roll torque applied on the tilting assembly and its flywheel assembly 100 may be measured with a force sensor. The force sensor measuring the precession forces may be installed on the steering linkage 816 and may alternatively be installed on the flywheel's axle 105. The measurement of the precession torque may be further improved by removing from it the forces from the angular acceleration of the flywheel's gimbal 112 axis of rotation. A known application of a similar method to determine the forces on the lateral axis of the tilting assembly and the tilt angle error 885 is the gyro monorail from Louis Philip Brennan U.S. Pat. No. 796,893A.

In an embodiment, the stability enhancement controller 809 may determine more than one tilt angle error 885 and with different tilt angle error sensor to provide a redundancy.

In an embodiment, the stability enhancement controller 809 may use two estimated tilt angle errors 885 to determine the stability enhancement steering 810 commands transmitted to the steering controller 850.

In an embodiment, a microcontroller and multiple sensors may be used by the stability enhancement controller 809 to determine the stability enhancement steering 810 applied.

In an embodiment, the sensor's signal, the signal's filtering, the estimation of the tilt angle error 885 and the proportional correction may be tuned to optimize the performance, the comfort, the level of assistance or other aspects of the stability enhancement steering 810.

In an embodiment, the sensor signal, the signal filtering, the estimation of the angle error 885 and the level of assistance from the stability enhancement controller 809 may be tuned and optimized by the user and one of the known automatic optimizations and tuning method like artificial intelligence and mathematical optimization.

In an embodiment, the level of traction on the road may be estimated with sensors to determine an additional traction assistance 883 applied by the stability enhancement steering 810 to compensate with a roll torque of the lateral slippage. The lateral slippage may be determined by comparing the roll acceleration measured by a MEMS gyroscope sensor with the lateral acceleration of two MEMS accelerometers located at two different heights on the tilting assembly. The difference between the reading of the two MEMS accelerometer not coming from the measured roll acceleration may be used to estimate the lateral slippage to compensate with the stability enhancement steering 810. The motorcycle industry already uses means to detect slippage and limit accelerations and braking on many commercial motorcycle models equipped with “traction control”.

### The Steering Assembly

The steering assembly 815 may provide the steering enhancement method with a means to apply the forces controlling the trajectory and the stability of the tilting vehicle 500 thru the steering of its multiple steered components (e.g., with a steering controller) as a single steered assembly.

It will be appreciated that, in the current disclosure, the steered components of the steering assembly 815 are referred to as a steered assembly 899, which are not to be confused with the other components of the steering assembly 815 (e.g., the components around the steered components).

In an embodiment, the steering assembly 815 may be steered in part by the steering controller 850. For example, the steering assembly 815 can be steered in part by the manual force (e.g., torque) of the driver and steered in part (e.g., complementarily steered) by the steering controller 850.

In an embodiment, the steering assembly 815 may be solely steered by the steering controller 850.

The steering controller 850 may combine and assist the driver steering 855, the stability enhancement steering 810 or both. The steering controller 850 may apply the combined and assisted steering to the steering assembly 815. Thus, the steering assembly 815 may be concurrently and cooperatively steered by the driver steering 855, the stability enhancement steering 810 or both by the steering controller 850.

The steering assembly 815 may steer it's at least one trajectory controller 705 and it's at least one flywheel's gimbal 112 as a single assembly. The steering assembly 815 may interconnect the steered position of the trajectory controller 705 and the steered position of the flywheel's gimbal 112 with a steering linkage 816. This may allow the steering of the steering assembly 815 to simultaneously steer the steered position of its trajectory controller 705 and the steered position of its flywheel's gimbal 112 in a single steering action. This may provide the steering controller 850 and the driver 855 and the stability enhancement controller 809 connected to it with a simplified steering interface compared to an independent steering of the trajectory controller 705 and the flywheel's gimbal 112.

The steering assembly 815 may make the steered assembly easier to control, easier to sense and easier to predict for the steering controller 850, the driver 855 and the stability enhancement controller 809 because the components of the steering assembly 815 may be steered as an assembly rather than individually. This may increase the ability to predict the impact from the steering of the components of the steering assembly 815, increase the driver's 855 control of the trajectory and the balance in some conditions.

### The Flywheel's Gimbal

The flywheel's gimbal 112 may support at least one flywheel assembly and enable a steering torque to be received from it when a roll torque is applied on the vehicle and to apply a roll torque on the vehicle when a steering torque is applied to it.

The flywheel's gimbal 112 of the steering assembly 815 may be attached to at least one flywheel assembly 100. The flywheel's gimbal 112 may have its gimbal's axis 845 pivotally attached to the tilting assembly. The gimbal's axis 845 of the flywheel's gimbal 112 may be substantially perpendicular to a flywheel's axle 105 of the flywheel assembly 100. The normal/regular/initial/default orientation of the gimbal's axis 845 and the normal/regular/initial/default orientation of its corresponding flywheel's axle 105 may be selected to transfer a precession torque at least in part in the roll axis of the tilting assembly when the flywheel's gimbal 112 is steered around its normal orientation. This may provide the steering assembly 815 with a means to apply a roll torque from the steering of the flywheel's gimbal 112 and to receive a steering torque from the flywheel's gimbal 112 when a roll torque is applied on the tilting assembly.

Someone skilled in the art may find many combinations of normal orientation of the gimbal's axis 845 and normal orientation of its flywheel's axle 105 able to provide the steering assembly 815 with a means to apply a precession torque at least in part in the roll axis of tilting assembly when steered around its normal orientation.

It will therefore be understood that the one or more flywheel's gimbal 112 may have its gimbal's axis 845 rotatably attached and substantially perpendicular to the longitudinal axis of the tilting assembly of the vehicle (e.g., the fork 514 when the flywheel is inside the front wheel). The one or more flywheel's gimbal 112 may support (directly or indirectly) one or more flywheel's axle 105, which may be substantially perpendicular to the orientation of the gimbal's axis 845. It can further be understood that the “normal” or regular orientation of the flywheel's axle 105 may be substantially perpendicular to the longitudinal axis of the vehicle.

It will also be understood that the flywheel's gimbal 112 may not be limited to the general definition of gimbal (i.e., passive gimbal) and may use a steering actuator 818 to change the orientation of the flywheel assembly 100 and may own only one steered gimbal's axis 845 oriented substantially perpendicular to the roll axis of the tilting assembly of the vehicle. It will also be understood that a gimbal with more than one pivot and linkage may be used to support the flywheel assembly 100 and steer its orientation.

In one embodiment, the steering enhancement method may use a vertical normal orientation of the axis of the flywheel's gimbal 112 and a lateral normal orientation of its corresponding flywheel's axle 835.

In one other embodiment, the steering enhancement method may use a lateral normal orientation of the axis of the flywheel's gimbal 112 and a vertical normal orientation of its corresponding flywheel's axle 835 as a means for the method to apply a roll torque on the tilting assembly when steered around its normal orientation.

The steering enhancement method may use a steering assembly 815 with one or more flywheel's gimbal 112.

In one embodiment, two counter rotating flywheel assembly 100 located in two different flywheel's gimbal 112 may be used to cancel one another's angular momentum in some conditions. This is a technique known in the art as exemplified in the patent U.S. Pat. No. 796,893A.

### The Flywheel Assembly

In its normal operation, one or more flywheel assembly 100 may be spinning continuously over the minimum speed required to apply a precession torque in the roll axis when the flywheel's gimbal 112 is steered with the steering enhancement method.

In one embodiment, the steering controller 850 may use an angular momentum controller 880 to adjust the rotational velocity of the one or more flywheel assembly 100 following a corresponding vehicle speed profile configured. The speed profile configured may be changed based on the driver's configuration, the limit set by the factory setting and/or other vehicle's parameter.

The flywheel assembly 100 may contain a flywheel's stator 104 and a flywheel's rotor 106 rotating the flywheel's rotating mass 118 around the flywheel's axle 105.

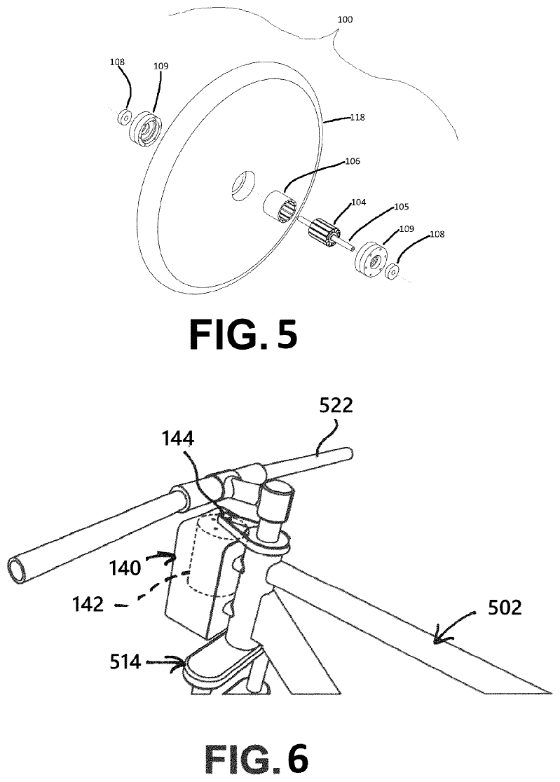

As seen in FIG. 5, in one embodiment, the flywheel assembly 100 may contain a motor composed of a flywheel's stator 104 and a flywheel's rotor 106 rotating the flywheel's rotating mass 118 around the flywheel's axle 105. The flywheel's rotating mass 118 may be coaxially mounted on a cylindrical flywheel's rotor 106. The flywheel's rotor 106 may be coaxially and rotatably mounted on a flywheel's axle 105 and around the flywheel's stator 104. The flywheel's stator 104 may be coaxially mounted to the flywheel's axle 105 and inside the flywheel's rotor 106. Therefore, as seen in one embodiment this configuration may enable a more compact configuration and the use of a larger and more powerful motor/generator hidden at the center of the flywheel while enabling the use of a wheel at the outside periphery of the flywheel assembly to support the vehicle and steer the trajectory.

In an embodiment, the proposed flywheel assembly 100 may have some similarity with the known design of electric wheel hub motor but with the difference that an embodiment of the flywheel assembly 100 similar to the one presented in FIG. 5 replaces the tire of the typical hub motor with a flywheel's rotating mass 118. The flywheel's stator 104 and axle 105 may contain sensors to measure the position and the precession torque from the flywheel's rotating mass 118. In one embodiment the flywheel's stator 104 may use the energy from the battery or from the vehicle's regenerative braking to power the rotation of the flywheel's rotating mass 118. Alternatively, the kinetic energy in the flywheel assembly 100 may be used to power the vehicle. The flywheel's electric motor may also be used as a regenerative brake to stop the flywheel's rotation if necessary.

In one embodiment, the flywheel's motor may be any other suitable type of motor like a hydraulic motor, a pneumatic motor or a mechanical system. In one embodiment, the wheel or the engine rotation may be mechanically linked to power the rotation of the flywheel's rotating mass 118.

The flywheel's rotating mass 118 may be a uniform disc rotating around its axis. It may also be shaped with more of its weight at the periphery to increase the angular momentum stored for a given mass, angular velocity and diameter.

The flywheel's rotating mass 118 may be composed of alloy steel, aluminum alloy, carbon fiber, glass fiber or any other known material meeting the specific requirements.

The flywheel's rotating mass 118 may be composed of composite material with its fiber oriented to increase the mechanical strength in the direction for the forces involved.

The flywheel's rotating mass 118 may be made of composite with an additive manufacturing process.

The flywheel's rotating mass 118 may be made of composite with a continuous filament winding process.

The flywheel's rotating mass 118 may be made of composite assembled by an automated fiber placement machine.

The flywheel's rotating mass 118 may be connected to the flywheel's rotor 106 through a flexible flywheel linkage reducing the load on the bearing and the vibrations transmitted between the flywheel's rotating mass 118 and the flywheel's rotor 106. The proper adjustment of the flexibility of the flexible flywheel linkage may reduce vibrations from the rotation of the flywheel's rotating mass 118 transmitted to the rest of the vehicle. The design of the flexible flywheel linkage and its application to the flywheel assembly and gimbal have come a common point with the known use of harmonic dampers but with axial and radial freedom tuned for the flywheel's rotating mass 118 normal speed range and load.

The flexible flywheel linkage may flexible, elastic, elastomeric, rubbery, springy, bouncy, souple or a combination thereof, and can be made, at least in part, from a selection of springs, flexures, elastomers, gases or a combination of these.

Additive manufacturing processes may enable the adjustment some of its physical properties, for example, by adjusting the ratio of the flexible material (e.g., elastomer) and added components, such as composite fiber (e.g., fiberglass). In some embodiments, the physical properties of the flexible flywheel linkage can be modified, adjusted and/or controlled by selecting the orientation of the composite fiber produced and the geometry to produce the desired level of dampening while providing the mechanical strength to resist the centrifugal forces and road impacts. This may provide the system with the ability to reduce the vibrations transferred to the various sensors (e.g., accelerometer), to the bearings supporting the flywheel and to the actuator of the steering controller 850 while producing a cheaper, lighter and more durable flywheel.

In one embodiment, the mechanical resonant frequency of the flywheel's rotating mass 118 relative to the vehicle may be tuned to be under the frequency of the mass spinning in operation, therefore reducing the vibrations when spinning over this critical speed of rotation.

### The Trajectory Controller

The trajectory controller 705 may be the member directing the trajectory of the vehicle. The trajectory controller 705 may be composed of one or more member selected from the group consisting of wheels, skis, floats, rudders, skates, continuous tracks, etc.

In the case of the trajectory steered by means of engaging a surface support, the trajectory controller may be a surface engaging steering member composed of one or more member selected from the group consisting of wheels, skis, floats, skates, continuous tracks, etc.

In an embodiment, the trajectory controller 705 may be a front wheel of a regular bicycle equipped with a tire and a valve stem accessible from the side of the wheel to inflate the tire.

The front wheel of most bicycle and motorcycle may be suitable to provide the trajectory controller 705 for the application of the steering enhancement method. In one embodiment, the spoke of the steered wheel may be replaced by a disc to free the space inside the rim for the flywheel assembly 100. In one embodiment, the wheel facing cover 524 can replace the spoke and may be attached to the rim with screws and to the flywheel's axle 835 with bearings.

The steering enhancement method may be used with one or more steered wheel. In an embodiment, the vehicle may use two front wheels tilting with the tilting assembly and steering the trajectory together as the trajectory controller 705.

One embodiment may be a motorcycle using a front steered wheel and a rear steered wheel linked together by a steering linkage 816 as the trajectory controller 705.

The increased stability and agility provided by the proposed method may enable more freedom in the selection of the steering geometry of the trajectory controller 705 because the method may not rely only on the steering geometry and the driver's steering to balance the vehicle. The steering enhancement method may also rely on the steering assembly 815, its flywheel assembly 100 and the steering controller 850 to maintain the balance.

The steering enhancement method may be used with the steered wheel 817 replaced by steered at least one ski, steered float or other similar devices to control the vehicle's trajectory.

It will be appreciated that the tilting wheeled vehicle 500 may also be a tilting vehicle directing its trajectory with devices replacing the wheels.

It will therefore be understood that the steered wheel may not be limited to a wheel and can alternatively be any type of suitable trajectory controller 705 that may be in contact with the supporting surface on which the tilting vehicle is driving (e.g., snow, water, ground air), such as a sky, a continuous track, a rudder, a ruder or a combination thereof. It is therefore understood that, in the present document, a steered wheel encompasses all of the possible suitable alternative someone skilled in the art could consider.

In one embodiment, the flywheel assembly 100 and the wheel may also include a drive train assembly 512 mounted in parallel with the flywheel assembly 100, inside the wheel or outside the wheel to propel the wheel of the vehicle.

### The Steering Linkage

The steering assembly 815 may use one or more steering linkage 816 to interconnect the steered position of its one or more flywheel's gimbal 112 with the steered position of the one or more trajectory controller 705. The steered components of the steering assembly 815 may be referred to as a steered assembly. The steering linkage 816 may be proportionally pivoting the steered position of the flywheel's gimbal 112 relative to the steered position of the one or more trajectory controller 705.

As illustrated in FIGS. 9 to 13 and 21 to 23, for example, in some embodiments, the steering linkage 816 of the steering assembly 815 can be made of rigid connections/linkages. In an embodiment, the rigid connection ensures simultaneous steering/control of the steered position of various components of the steering assembly 815 as relative to one another. In an embodiment, the rigid linkage can comprise mechanical linkages, hydraulic linkages, any non-deformable parts, or a combination thereof.

One embodiment may use two interconnected hydraulic steering actuators as a mean to rigidly and proportionally interconnect the steered position of two steered components of the steering assembly. The two interconnected steering actuators may be transferring the hydraulic fluid from one to the other as a mean to transfer the displacement of one to the other. One embodiment may use a steering motor actuator 142 actuator to apply the steering controller's assistance and two interconnected hydraulic actuators as the steering linkage 816 proportionally transferring the mechanical displacement from one steered component to another.

The sum of the forces applied on the steering assembly 815 and from the steering assembly 815 may determine the steered position of the steering assembly 815. The steering assembly 815 may be steered by the forces from the steering controller 850, from the flywheel's gimbal 112 and from the trajectory controller 705.

In one embodiment, one or more steering linkage 816 may be provided by two or more steering actuator 818 having their position linked to one another following a pre-determined steering ratio. This may in some conditions enable the use of a steering actuator 818 as a steering linkage 816 and as a steering actuator 818 at the same time if provided with steering actuators 818 fast, powerful and precise enough to maintain the relative position. A preferred embodiment may use a mechanical linkage over the use of interconnected electromechanical actuators as the steering linkage considering the requirements of such steering actuators 818.

The use of motorized linear actuator as a steering rod with an adjustable length may be suitable to provide the steering linkage 816 with its function of rigid interconnection (e.g., simultaneous positioning) of the steered position of the trajectory controller 705 relative to the steered position of the flywheel's gimbal of the steering assembly 815. It may also enable the application of a bias between the steered components of the steering assembly 815 (e.g., a bias between the steered position of flywheel's gimbal 112 relative to the steered position of the trajectory controller 705). This may enable the use of a coordinated steering (e.g., the independent steering of the components), in a special condition, while maintaining the interconnection of the steered position of the steering linkage.

The use of multiple steering actuator 818 as a steering linkage or the use of a linear actuator as the steering linkage 816 (e.g., to replace the motor steering linkage 132) may, in some special conditions (e.g., emergency steering), momentarily replace the simultaneous steering (e.g., as defined by a steering linkage determining the steered position of the components as relative to one another) with a coordinated steering enabling some level of independent steering of the flywheel's gimbal 112 steered position relative to the trajectory controller's 705 steered position (e.g., with a bias between the steered position commanded to the multiple steering actuator or the linear actuator used as bias from the motor steering linkage 132).

In one embodiment, the special condition initiating the transition from a simultaneous steering to the coordinated steering (e.g., independent steering) may be when the applied driver's steering torque reaches a predetermined limit (e.g., a vehicle lean toward a nearby wall substantially parallel to the current trajectory, a driver applies a steering torque over a predetermined limit to stop the trajectory of the vehicle from entering in a collision with the wall, to restore the stability, to restore the stability, the steering controller 859 momentarily operate a coordinated steering by inserting a bias on the steering command of the steering actuator 818 steering the flywheel's gimbal 112 to apply a roll torque restoring the balance while letting the steering actuator of the trajectory controller to steering away from that direction).

Another case where one embodiment may use the coordinated steering (e.g., independent steering) of steering actuator 818 used as a steering linkage is when the steering controller 850 is equipped with a distance measuring camera to detect the presence of an obstacle along the side of the vehicle, therefore limiting the steering that can be done in that direction to bring back the balance without to enter into a collision.

One embodiment using the coordinated steering (e.g., independent steering) of the steered components in special conditions may use the steering controller 850 to slowly reduce the bias inserted between the steered position of the steered components (e.g., returning the linear actuator to its normal length or reducing the bias between the steered position of the actuator used as a steering linkage 816) once the special conditions is resolved, therefore returning to the simultaneous steering function of the steering linkage's steering the position of the trajectory controller 705 the position of the flywheel's gimbal's 112 as relative to one another.

The one or more steering linkage 816 may orient the at least one flywheel's gimbal 112, the at least one trajectory controller 705 and the at least one steering controller 850 to be substantially centered (e.g., in the normal orientation) when one of them is centered.

It may be understood in this situation that the centered orientation of the trajectory controller 705 is with the vehicle processing in a straight trajectory and that the centered orientation of the flywheel's gimbal 112 is with the flywheel's axis of rotation substantially perpendicular to the longitudinal axis of the vehicle.

The steering linkage 816 may orient the steering of the one or more flywheel's gimbal 112 to generate a roll torque on the tilting assembly oriented substantially toward the right when the vehicle is steered toward the left and a roll torque on the tilting assembly oriented substantially toward the left when the vehicle is steered toward the right. Whereby, the roll torque from the combined steering of the at least one flywheel's gimbal 112 and the at least one trajectory controller 705 may enhance at least some of the other effects on the stability and the agility of the vehicle.

It may be understood that steering toward the right may generate a steering rate displacing the steered orientation of the trajectory controller 705 toward the right causing flywheel assembly 100 to apply a torque at least in part in the roll axis of the tilting assembly and toward a leftward leaning. It may be understood that steering toward the left may generate a steering rate displacing the steered orientation of the trajectory controller 705 toward the right causing flywheel assembly 100 to apply a torque at least in part in the roll axis of the tilting assembly and toward a leftward leaning.

When the tilting assembly roll because an external lateral force is applied to it while the vehicle travels forward, the flywheel's gimbal 112 apply a steering torque that steers the one or more trajectory controller 705 to direct the tilting vehicle 500 into the roll, therefore generating a roll torque on the tilting assembly compensating at least in part for the external lateral force. This may contribute at least in part to increase the stability of the tilting assembly. In an embodiment, this effect may contribute at least in part to the stability of the vehicle.

The one or more steering linkage 816 interconnecting the components of the steering assembly 815 can be suitably provided from the group consisting of a belt with pulleys, gears, interconnected hydraulic actuators, interconnected electromechanical actuators, interconnected universal joint, connecting rods connected to steering arm or any other suitable mean to link the steering of the steering assembly 815.

In one embodiment, the rigidity and strength of the steering linkage 816 may contribute to the synchronization of the forces applied by the steered components, the synchronization of the seered position of the steered components, and to reduce the power required for the steering actuator 818 to balance the vehicle.

In one embodiment, the rigidity and strength of the steering linkage 816 may reduce the oscillation of the steering happening in some conditions such as capsize, weave, and wobble.

In one embodiment, the rigidity and strength of the steering linkage 816 may reduce the oscillation due to the improper steering lead and lag between the steered components that can be at the origin of a negative feedback loop.

It will be appreciated that it may add complications if the orientation of the steering linkage 816 interconnecting the steering of the trajectory controller 705 with the steering of the flywheel gimbals 112 is inverted because the roll torque from the steering of the steered gimbal will, in some conditions, counteract the roll torque from trajectory controller, making the system highly difficult to drive.

It will be appreciated that reversing the angular momentum stored in a flywheel assembly 100 used for the steering enhancement method (e.g., to spin backward instead of forward) without changing accordingly the steering linkage 816 may add complications because it would make, in some conditions, the roll torque from steering of the flywheel's gimbal opposed to the roll torque from the trajectory controller instead of enhancing it.

### The Steering Ratio

The steering ratio may be is the ratio between the displacement of a steered component and the corresponding displacement of another steered component linked to it. The steering ratio may be adjusted to be positive or negative. The steering ratio may be adjusted manually with a steering ratio adjustment. The steering ratio may be adjusted by a command sent to a steering ratio actuator. The steering ratio may be adjusted automatically by a steering ratio actuator controlled based on the appropriate vehicle parameter such as its speed and its weight and the angular momentum in the one or more flywheel assembly 100.

An embodiment may adjust the steering ratio of the manually operated steering input 522, the steered wheel 705 or the flywheel's gimbal 112 to improve the steering feedback or the control of the steering assembly 815.

### The Gimbal's Ratio Adjustment

The steering ratio of the flywheel's gimbal 112 relative to the other flywheel gimbal 112 and/or the trajectory controller may be adjusted by a gimbal's ratio adjustment 863.

The gimbal's ratio adjustment 863 may be remotely adjusted by a steering ratio actuator to increase the gimbal's steering when the vehicle travel at low speed or standstill or to provide an increased roll torque from a given displacement of the steering assembly 815. Furthermore, this may reduce the steering displacement of the trajectory controller 705 and the manually operated steering input 522 necessary to apply the roll torque required to balance the vehicle at low speed.

In one embodiment, the gimbal's ratio adjustment 863 may be automatically adjusted based on the vehicle's speed to provide an increased gimbal steering at low vehicle speed.

In an embodiment, the gimbal's ratio adjustment 863 may also be automatically adjusted based on the vehicle's speed to provide an increased gimbal steering at high vehicle speed.

In an embodiment, the gimbal's ratio adjustment 863 may be adjusted with a steering ratio actuator changing the effective length of the torque arm of the flywheel's gimbal 112. This may decrease the amount of steering done by the steered wheel 705 and the manually operated steering input 522 to apply the roll torque required to balance the vehicle at low speed or high speed.

In one embodiment, the use of multiple steering actuator 816 as the steering linkage may enable the steering controller 850 to adjust the gimbal ratio adjustment and to use positive or negative ratio.

In some embodiment, the steering controller 850 may also adjust the steering ratio of multiple steering actuator 818 used as a steering linkage 816.

One embodiment may use multiple steering actuator 816 to reverse the orientation of the steering linkage 816 applied with a steering motor and reverse at the same time the rotation of the flywheel, therefore maintaining the ability to use it for the stability enhancement method after reversing the rotation. This may enable the use of a flywheel assembly to store a forward angular momentum and to be steered in the same direction as the trajectory controller when the vehicle travel at low speed and to reverse the steering ratio (e.g., to be negative and opposite to the steered direction of the trajectory controller 705) and the direction of rotation of the flywheel assembly (e.g., to spin in the backward direction) when the vehicle travel at high speed. One embodiment may reverse the angular momentum stored in a flywheel for the use of the inertial compensation method (described later) while maintaining the ability to use it for the steering enhancement method if using multiple steering actuators 818 as the steering linkage.

### The Steering Controller

The steering controller 850 may steer the steering assembly 815 based on the received driver steering 855, the received stability enhancement steering 810, the steering controller assistance 892 or a combination of these elements.

The steering controller 850 may have similarities with the known use of the electric power steering seen in some car but with the increased benefit of increasing the stability when used with the proposed method.

The steering controller 850 may use one or a combination of electronic or mechanical analog controller, microcontroller, field programmable gate arrays (FPGA) or any other suitable means to determine the assistance to be applied by a steering actuator 818.

The steering controller 850 may also use cameras, geo-localization devices, magnetometers and other sensors and peripheral to determine the actions to take. As would be obvious to someone familiar with the latest technologies involved in autonomous vehicles of the prior art, the controller means of the invention may be further suitably configured and adapted for supporting additional known functions such as, for example, global positioning system (GPS) location, camera and light detection and ranging (LidAR) technologies for detecting obstacles, surrounding ground profile and the vehicle attitude, weather conditions, wireless communication means, AI software capabilities, and the likes, for remote control and/or for autonomously operating the wheeled vehicle 500 along a predetermined path or reach a predetermined destination.

The steering actuator 818 may be a device steering the steering assembly 815 based on the assistance determined by the steering controller 850. The steering actuator 818 may be a steering motor 142, a mechanical actuator or a combination of the two types. By example, in one embodiment, the steering actuator 818 may be provided by the combination of a mechanical actuator transmitting the forces from the manually operated steering input 522 to the steered assembly and a steering motor 142 converting the assistance determined by the steering controller 850 into a steering torque from the steering motor 142 applied to steer the steering assembly 815.

The steering controller 850 may be a means to enhance the received driver steering 855 or the received stability enhancement steering 810 or both with a steering controller's 850 assistance in the direction of the applied torque and proportional to the applied torque. This may enable the driver to steer the vehicle as a regular vehicle (e.g.; as a torque controlled trajectory) but with reduced effort and an increased collaboration with the steering controller's 850 assistance.

In an embodiment, the steering controller 850 may apply a linearization gain to the received driver steering 855 and/or to the received stability enhancement steering 810 and add the result to the determined steering controller's 850 assistance. The steering controller 850 may also determine a centering assistance 882 and a traction assistance 883 to add to the determined steering controller's 850 assistance.

In an embodiment, the steering controller 850 may linearize the steering response of the steering assembly 815 based on a vehicle speed sensor's 808, a steering position sensor 954, the steering ratio, the angular momentum stored in the flywheel assembly 100 and other parameters affecting the steering response.

In one embodiment, to linearize the response of the steering controller's 850 assistance, the linearization gain may be reduced at high vehicle speed.

One embodiment may supplement the steering controller assistance 892 with a centering assistance 882. The centering assistance 882 may be adjusted based on the vehicle's speed. The centering assistance 882 may increase the comfort and maintain the steering assembly 815 around the centered position when no steering input is applied by the driver 855. This may improve the ability of the tilting assembly to remain upright because it can maintain the steering assembly 815 away from the limit of the steered position where it cannot apply a precession torque in the roll axis to balance the tilting assembly with the steering of the flywheel's gimbal. In other words, the centering assistance 882 can be used to ensure that the steering assembly 815 remains centered around the desired direction (e.g., around the normal orientation or a desired steered position), which can prevent the steering assembly 815 from reaching a maximal steering position.

It may be understood that the steering assembly 815 may not be able to steer at an angle larger than a maximal steering position (e.g., typically of about) 80° toward the right and the left of the vehicle and that the precession torque in the roll axis of the vehicle generated by a given amount of steering rate may decrease as the steered position increase toward the right or the left.

The centering assistance 882 may supplement the steering controller's 850 assistance with a steering force away from the centered steering position. The steering torque steering away from the centered steering position may be similar to the known force generated by the steering geometry of regular motorcycle traveling at forward speed in its stable range. This steering controller's 850 assistance away from the centered position may generate a self-centering effect when its profile is adjusted properly because it may produce a compensating tilt angle error 855 steering the direction toward the centered position.

In one embodiment, the centering assistance 882 from the steering controller 850 may be increased when the vehicle is at lower speed or in parking mode to increase the self-balancing ability of the vehicle.

The steering controller 850 may apply a roll torque by sending command to the drive train assembly 512 when the steered angle is large enough to displace the contact point of the vehicle on the support surface substantially laterally relative to the center of mass.

This method has some similarities with the inverted pendulum balancing where the contact point on the support surface is displaced to maintain the balance. This technique may be integrated in the steering controller 850 already equipped with the stability enhancement method.

The steering controller 850 may be configured to increasingly use the drive train assembly 512 to apply the roll torque when the steered angle is over a preconfigured value toward the right or the left.

The combination of roll torque from the lateral displacement of the trajectory controller 705 on its support surface, using the drive train assembly 512 and roll torque from the steering of the steering assembly 815 may provide multiple advantages. As the roll torque from a given amount of steering rate may reduce at large steering angle of the steering assembly 815 when the vehicle process at low or no speed, the roll torque from a given amount of displacement of the drive train may increase. Therefore, they may complement one another ability to apply roll torque in different steering angle.

An embodiment may use a front-wheel drive or a rear-wheel drive to accelerate the vehicle forward or backward in the steered trajectory and apply a corresponding roll torque.

In one embodiment, a typical electric bicycle equipped with a rear hub motor may be used to apply the balancing roll torque by steering the steering assembly when the steered angle is low and by using the drive train assembly 512 to move the vehicle sideways when the steered angle is high.

An embodiment may automatically and gradually switch between the two balancing assistance based on the position of the steered assembly.

The steering controller 850 may keep track of the forward and backward displacement done to balance the vehicle thru the drive train assembly 512 and use a closed loop displacement controller 888 to maintain this value around zero. The closed loop displacement controller 888 may enable the steering controller 850 to limit the total forward and lateral displacement done to balance the vehicle. The closed loop displacement controller 888 may also compensate forces applied by uneven support surface on the drive train assembly 512.

The steering controller 850 may also use linearization factors automatically adjusted based on the vehicle's speed sensor 808 and steering position sensor 954 to determine a ratio of roll torque applied with the steering actuator 818 relative to the roll torque applied with the drive train assembly 512.

In one embodiment the steering controller 850, may apply the assistance with the steering actuator 818 and the drive train assembly 512 based on its determined ratio and may invert the direction of the assistance applied with the drive train assembly 512 for steering angle toward the left since the inversion of the steered direction of the steering assembly may also invert the direction of the roll torque applied by the drive train assembly 512.

Many types of steering oscillation may be reduced by using the steering controller 850 as a steering damper. The steering controller 850 may measure the steering torque from the steering assembly 815 and limit it with a steering damper assistance if an undesirable force is detected. The steering torque from the steering assembly 815 may be determined by comparing the angular acceleration of the steering assembly 815 with the steering torque applied to it.

Various oscillations of the steering assembly 815 are known by experts in the field and the method to identify and limit them are also known.

However, to use a single motor to act simultaneously and/or sequentially as a steering damper, as an adjustable centering force, as a gimbal actuator and/or as a power steering and/or as a flywheel's gimbal 112 actuator would be considered an improvement over the current state-of-the-art.

The steering actuator 818 of the steering controller 850 may apply the determined steering torque to the steering assembly 815. The steering actuator 818 may also be used as a brake or a generator to absorb the steering kickback or oscillation from steering assembly 815 when necessary.

The steering actuator 818 of the steering controller 850 may be a torque motor operated as a torque-controlled motor to enable the torque from the manually operated steering input 522 and the steering torque from the steering assembly 815 to steer the steering assembly 815 with a reduced interference from the steering motor 142.

The steering motor 142 of the steering controller 850 may also be operated as a torque controlled motor with a feedback from the angular speed and acceleration measured by the steering position sensor 954. The feedback may be used to limit the effect of the steering torque from the steering assembly 815, for example to limit oscillations from an impact of the vehicle on the road surface. The steering controller 850 controlling the steering motor 142 may increase the gain and apply a steering torque in the direction opposite to the angular speed and acceleration detected by the steering position sensor 954. The steering motor 142 feedback may be used in one of the embodiments to control the level of feedback from the road transmitted to the driver 855 thru the manually operated steering input 522. The steering motor's 142 feedback may also be used as a damper to limit the steering oscillations at some vehicle's speed.

In one embodiment, while the vehicle moves at low speed, the increased steering friction from the tire rubbing on the ground may be compensated by the steering motor 142 feedback.

In an embodiment, at low vehicle speed, the steering motor 142 feedback may provide an increased gain and an additional assistance in the direction opposite to the angular velocity and acceleration detected by the steering position sensor 954. For example, the steering actuator can control the steering rate at low vehicle speed and/or the steering torque at high vehicle speed, which can be achieved, in some embodiments, with a transition between various level of assistance that can be defined by a linearization gain and can happen gradually between various speeds (e.g., between low vehicle speed—between about 0 km/h to about 10 km/h—and higher vehicle speed).

In one embodiment, the steering motor 142 of the steering controller 850 may be operated as a torque controlled motor with an adjustable steering motor 142 feedback assistance. The method used in some embodiments may act like a proportional-integral-derivative (PID) loop reducing the speed and acceleration of the steering motor 142, where “P” can be the torque, “I” can be the speed of the steering motor 142 and “D” can be the acceleration of the steering motor 142. In one embodiment, these PID coefficients of the steering motor 142 feedback may be automatically adjusted by the steering controller 850 based on the vehicle's speed as determined by a predetermined profile.

Note that the definition of a PID proposed herein may not be limited to the strict conventional definitions of a PID and that, in the present disclosure, the PID can include a simple PD assistance, a feedforward assistance or a fuzzy logic assistance.

In the case where the driver's steering torque 857 is manually applied to the steering controller 850, the steering controller 850 may measure the driver's steering torque 857 with a steering torque sensor 953, and may multiply its measure with linearization gain to determine the corresponding steering actuator's 818 assistance. The corresponding steering command may be applied by a steering motor 142 to the steering assembly 815 combined with the other steering controller's 850 assistance. The driver's steering torque 857 applied to the steering controller 850 may also be mechanically transferred to the steered assembly 899 by a mechanical actuator (e.g., a bicycle stem and a bicycle steerer tube) to provide a redundant pathway for the driver to apply a steering torque. This may enable the driver to steer the trajectory and to balance of the vehicle with a manually operated steering input 522 (e.g., as a torque controlled trajectory with a position feedback if the vehicle travel at high speed or with an increased steering to balance at low speed) even in the case of a failure of the steering controller's 850 steering motor's 142 assistance.

The steering controller 850 may be made with components similar to the well-known electrical power steering from cars.

In an embodiment, this means that the manual steering can remain operational even if the steering controller 850 fails, which would imply that it fails to apply the additional steering torque. This may still permit the vehicle to be steered manually by the driver steering 855.

The various components and inner workings of the device providing steering actuator's 818 assistance can be, but are not limited to, the ones known in the art.

One embodiment may use a steering controller 850 to apply a linearization gain to the driver's 855 steering and the stability enhancement steering 810 signal to determine the corresponding steering controller's 850 assistance.

In an embodiment, the steering controller 850 may also apply a centering assistance, a traction assistance, a steering feedback assistance and a steering damper assistance. An embodiment may also contain a mechanical path for the driver's steering torque 857 be transferred to the steered assembly 899.

An embodiment may use a manually operated steering input 522 to apply a driver's steering torque 857 and/or receive feedback from the steering controller 850.

One embodiment may use a steering handle 522 similar to the one used on typical bicycles as the manually operated steering input 890 to receive the manually applied driver's steering command 898.

Many other types of interfaces such as side handles, steering wheels, foot steering and joysticks may provide a suitable s for the driver to transfer steering command to the steering controller 850 and/or to receive the steering feedback. This embodiment may benefit of the redundant means of ensuring the stability with the driver's steering mechanically transmitted to the steering assembly 815 and thru the use of the steering controller's assistance provided thru the steering actuator 818.

As known for cars and other types of vehicles, a steer-by-wire system may also be used as an intermediate step between the driver 855 and the steering controller 850. This may provide the steering controller 850 with a means to enhance the user's experience with the modulation of the steering ratio, the flexible steering input and the dampening of the feedback thru the adjustment of the parameter of the closed loop controller of the motor controlling the position and reading the torque applied on the manually operated steering input 522.

In the case where the driver's steering command 898 is a signal sent to the steering controller 850, the signal may be used by the steering controller 850 to determine the corresponding steering torque controlling the steered trajectory in the direction opposite to the applied torque, as with other previously described embodiment with manually operated steering input. This may enable the simple use of a signal to control the trajectory of the vehicle without to interfere with the ability of the vehicle to self-balance with the stability enhancement method because this is the way a manually operated steering input would behave.

In an embodiment, the received driver's steering command 898 may be linearized by the steering controller to produce a steered trajectory proportional to the received steering command 898.

In one embodiment, the steering controller 850 may have its components located in different locations. In one embodiment the steering motor may be located inside the vehicle's body and the manually operated steering input 522 may be located outside the vehicle to receive the driver's steering torque 857. Therefore, an embodiment may have a steering assembly 815 steered by a mechanical steering actuator 818 receiving a manually operated steering input 522 and by a steering motor 142 controlled by the determined steering controller's 850 assistance.

The steering controller 850 may use multiple steering actuator 818 transmitting steering forces from different steering motors 142 and/or mechanical actuators at the same time while ensuring the simultaneous steering if the steering actuators are powerful enough to reduce the lead lag and maintain the steering ratio.

In an embodiment, the selection of suitable peak torque, power and control loop may enable these motors to be used as a steering linkage simultaneously steering the position of the trajectory controller 705 and the position of the flywheel's gimbal following the predetermined ratio. In this case, the steering ratio between these motor used as a steering linkage 816 and their position may be interconnected by a typical “PID” loop where “P” can be a difference between their target positions (possibly including a bias in special conditions with coordinated steering), “I” can be the speed and “D” can be the acceleration. It is to be understood that the steering controller 850 may multiply the steering controller 850 assistance with the steering ratio of each steering actuator before to add it to the P component of each controlled steering actuator.

It must be understood that this “PID” loop may not be confused with other “PID” based on other definitions.

It is to be understood that the steering motor 142 may be a purely mechanical system like a hydraulic or pneumatic actuator or an electromechanical system like a torque motor, a dc motor or a stepper motor in a direct-drive configuration or via a suitable geared transmission.

The steering controller assistance 892 may be provided by a simpler system providing an assistance with only some of the proposed functionalities. In one embodiment, the more complex assistance functionalities may be offered only when desired (e.g., enable/disable manually or automatically). For example, in one embodiment, the steering controller's 850 assistance may provide assistance to the stability enhancement controller 809 only when asked by the driver 855.

An embodiment using the steering enhancement method may be adjusted to be used with a reduced stability enhancement steering 810 and with only the force amplification of the steering controller 850 when the vehicle operates in some conditions. This may enable the driver 855 to have more control over the steering applied to the steered assembly 899 but with a reduced steering controller assistance 892 in these conditions.

The steering motor 818 may be connected to the steered assembly 899 by belt and pulley, steering rod, gears or an equivalent.

In one embodiment, a timing belt may be used to connect a high torque electrical motor, used as the steering actuator 818 of the steering controller 850, to the steered assembly 899. This may provide the system with a favorable reduction ratio, a backlash-free operation, a low cogging torque, a low noise operation and an easy installation.

### The Driver Ratio Adjustment

A driver ratio adjustment may be used to adjust the steering ratio between the manually operated steering input 522 and the steering assembly 815.

In an embodiment, the driver ratio adjustment may be manually adjusted to the driver 855 preference.

The driver ratio adjustment may be automatically adjusted by a steering ratio actuator 862 based on the vehicle speed or other parameter suitable to improve the driver 855 experience. This may be used by example to reduce the displacement of the manually operated steering input 522 made by the steered assembly 899 when balancing the vehicle cruising at low speed.

The driver ratio adjustment 861 may be provided by a system as seen in one embodiment or made like other known power steering system using an electrically variable gear ratio.

### The Flexible Steering Input

The flexible steering input 574 may link the manually operated steering input 522 with the steering assembly 815. In an embodiment, the rapid position change of the steering assembly 815 may be transferred to the driver 855 and may be uncomfortable. The rapid position change of the steering assembly 815 may be caused by bump on the road, collision on the tilting assembly, headshake and tankslapper-style oscillations or strong assistance from the steering controller 850. A flexible steering input 574 may be installed between the manually operated steering input 522 and the steering actuator 818 to allow some flexibility between the position of these parts. The flexible steering input 574 may be manually adjusted or automatically adjusted based on the road conditions or user preference. Therefore, the flexible steering input 574 may be a means to provide the driver 855 with an improved comfort and protection from the rapid steering of the steered assembly 899 during various events, such as an impact and/or a lost of traction.

The flexible steering input 574 may be one of, or a combination of, springs, gas springs, rubbers, torsion bars, compliant mechanisms or any other known equivalent.

In an embodiment, the flexibility of the flexible steering input 574 may be manually adjusted by the user.

In an embodiment, the flexible steering input 574 may be automatically adjusted by the steering controller's 850.

In an embodiment, the flexible steering input 574 may be adjusted in a way similar to the known use of active suspension but with the objective of reducing the drivers steering feedback when rapid position changes of the steering assembly 815 are generated, e.g., from bumps of an uneven road surface or other similar conditions.

In an embodiment, a mechanical steering damper may also be installed between the steering of the steering assembly 815 and the vehicle's body to limit rapid feedback from position change of the steering assembly 815 on the driver. This is not to be confused with other uses of dampeners (e.g., a dampener between the steered assembly and the vehicle's body to dampen the steering assembly.)

In one embodiment not using the torque controlled trajectory of other embodiments described herein, the steering torque applied by the driver 855 on the manually operated steering input 522 and transmitted through a flexible steering input 574 to the steering controller 850 may be measured by a steering force sensor 953, used by the steering controller 850 to determine a corresponding steering torque applied by the steering actuator 818 in the direction opposite to the torque applied on the manually operated steering input 522 and larger than the applied force. This may enable the driver to steer the vehicle as a position controlled steering device with force feedback. This may provide a behavior more similar to the regular car steering in the direction of the applied torque as a position controlled input. It may be understood that, while assisting the manually applied driver steering force in the direction opposite to the applied driver steering force may affect the operation of the system, the other proposed assistance and benefits may remain possible while enabling others. This method may increase the dependence of the driver on the steering controller inverting the applied torque and require more adaptation of the driver's steering method to recover a steering actuator's failure (e.g., where the driver would need to suddenly invert the steering torque applied to steer and start steer the steering input as a torque controlled trajectory instead of a position controlled trajectory). It may be understood that the use of a steering controller's 850 to assist the manually applied driver's steering force in the direction opposite to the applied driver's steering force will reduce the ability of the system to collaborate with the applied driver's steering force and to recover from a steering actuator's failure.

### Operation of the Steering Enhancement Method

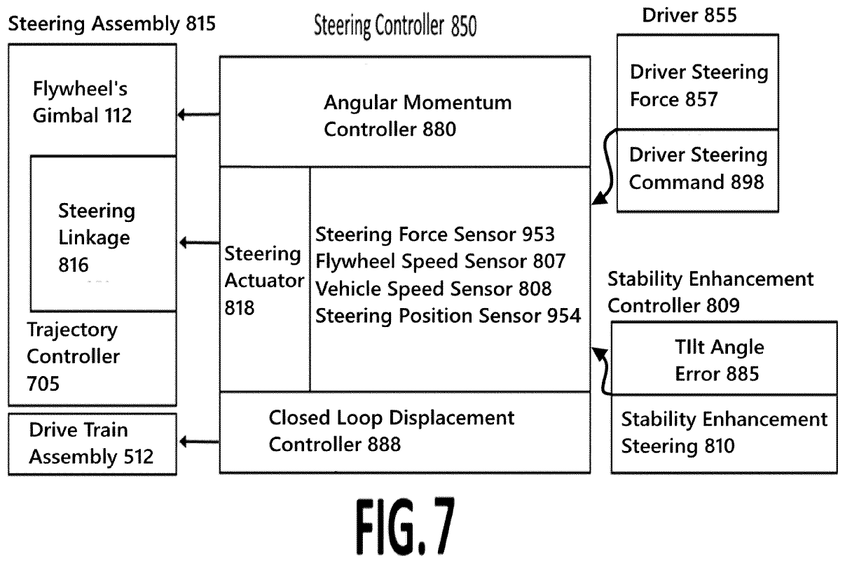

The FIG. 7 schematizes the general operation of the steering enhancement method as a whole. The driver 855 and the stability enhancement controller 809 may have their steering combined by the steering controller 850. The steering enhancement method may enable the driver 855 to operate the system with steering command similar to the one used to steer a regular motorcycle going forward in its stable speed range. This means the driver may steer and counter steer to maintain the balance and direct the trajectory at the same time. Unlike other systems using an assistance and gyroscope, this control method may be operated with a more predictable steering response and a more conventional steering control. Therefore, the system may provide more control, more safety and some level of natural redundancy.

In one embodiment, the driver 855 may apply on the manually operated steering input 522 a driver's steering torque 857 in the direction opposite to the desired steered trajectory of the vehicle and roughly proportional to the desired steered angle.

It will be appreciated the driver 855 may steer the steering assembly 815 as a driver may steer typical bikes, traveling at a forward speed in its stable range (e.g., as a torque controlled trajectory controller steering in the direction opposed to the applied torque and roughly proportional to the applied torque). This can also mean that, while the vehicle is traveling forward, the method may enable the drivers to apply a constant steering torque to the left in order to cause an initial steer angle to the left, a lean to the right, and eventually a steady-state lean to the right (e.g., balancing the lateral centrifugal forces and gravitational forces while maintaining the steered angle around the corresponding driver's command), a steer angle to the right, and thus a steered trajectory turning to the right, respectively. This can also mean that the driver steering 855 may gradually remove the steering torque applied to the steering assembly 815 to let the system return the steered trajectory to a straight line (e.g., centered or normal position). The rate at which the system will return into a straight trajectory may be determined by the centering assistance configured. The described method may also enable the driver to feel the position feedback from the steering assembly by holding the manually operated steering input 522 during the process.

One embodiment of a regular motorcycle equipped with the proposed steering enhancement method and traveling at low speed or standstill may be balanced without having to put a foot on the ground because the steering of the steered assembly 899 by the steering controller 850 and the stability enhancement controller 809 will produce a balancing roll torque even at such speeds. Furthermore, the steering of the steering assembly 815 done to balance the vehicle may be done at least in part automatically by the stability enhancement controller 809 and the steering controller 850.

It will be appreciated the driver 855 may steer the steering assembly 815 similarly to a driver steering a typical bike, traveling at a forward speed in its stable range (e.g., as a torque controlled trajectory controller steering in the direction opposed to the applied torque and roughly proportional to the applied torque) but while the vehicle is stopped. In that situation, the method may enable the drivers to apply a constant steering torque to the left in order to cause an initial steer angle to the left, a lean to the right, and eventually a mostly vertical steady state (e.g., balancing the gravitational force while maintaining the steered angle around the corresponding driver's command), and thus a steered position to the right respectively. This can also mean that the driver steering 855 may gradually remove the steering torque applied to the steering assembly 815 to let the system return the steered direction to a forward orientation (e.g., centered or normal position). The rate at which the system will return the steered direction into a straight trajectory may be determined by the centering assistance configured.

It will be appreciated that in one embodiment, the driver 855 may steer the trajectory of the vehicle by shifting his body weight on the side of the desired trajectory and roughly proportionally to the desired steering angle. This may enable the driver to steer the vehicle without using the handlebar at high speed (e.g., as would do a well-designed motorcycle traveling forward within its stable speed range) or at low speed or standstill.

Furthermore, the steering from the precession of the flywheel assembly 100 in the flywheel's gimbal 112 may steer (e.g., apply a steering torque on) the trajectory controller 705 to counteract at least in part of the lateral forces on the tilting assembly by steering the vehicle into the fall when the vehicle travels forward at sufficient speed.

The multiple embodiments presented show some possible combinations of the elements enabling the use and operation of the steering enhancement method. Someone skilled in the art should be able to determine multiple combinations, orientation and adjustments of the elements present in the proposed method to suit other applications or improvement to the steering enhancement method.

In an embodiment, the method of using and installing a kit can include a step of providing a tilting vehicle 500; a step of providing a steering enhancement apparatus; a step of equipping the tilting vehicle with the provided steering enhancement apparatus so that the stability enhancement and/or the steering enhancement is provided when in operation; a step of boarding the tilting vehicle; a step of accelerating the vehicle.

In an embodiment, the method of enhancing the stability and/or steering may include a step of initiating a turn by manually applying a steering force (e.g., in the direction opposed to the intended trajectory); a step of measuring/detecting the manually applied steering command; a step of measuring extern forces applied on the tilting vehicle; a step of determining a tilt angle error; a step of determining a stability enhancement command; a step of determining a steering command based on the determined stability enhancement command and the measured manually applied steering command; and a step of steering the steerable components (e.g., flywheel gimbal) of the inertial compensation apparatus to engage the tilting vehicle in the intended trajectory with at least one of a steering assistance and a stability assistance; repeating at least one of the previous steps.

### The Inertial Compensation Method

The proposed inertial compensation method may enable roll unstable vehicles (e.g., tilting vehicles and non-tilting vehicles) to compensate at least in part for the centrifugal forces present while taking a turn. The compensation of the centrifugal forces with the inertial compensation method may reduce the risk of tipping over for non-tilting vehicles and of losing control/balance of tilting vehicles. The compensation for the centrifugal forces with the inertial compensation method may reduce the lean angle necessary to compensate for the centrifugal forces on the tilting assembly when used on tilting vehicle 500.

The non-tilting vehicle using the proposed inertial compensation method may be a typical narrow track vehicle like narrow tandem cars or small single occupant vehicles. When a typical non-tilting vehicle is taking a turn, a weight transfer on the wheel at the outside of the turn of the vehicle may be necessary to generate a roll torque compensating for the roll torque 900 from the centrifugal force. In a typical non-tilting vehicle 603 not using the method, the weight transfer may not be able to compensate the centrifugal force with more than 100% of the weight of the vehicle applied on the wheel at the outside of the turn and without risking a vehicle rollover. This limits the maximum roll torque 900 from the centrifugal force's a regular vehicle can safely compensate and the corresponding speed and agility of these vehicles.

Most tilting vehicles 500 are suitable for the application of the proposed inertial compensation method. Typical tilting vehicle 500 may tilt the tilting assembly to counteract the centrifugal forces with the gravity forces applied on the tilting assembly and maintain the balance while the vehicle is taking a turn. Typical tilting vehicle 500 usually require time to initiate the leaning before taking a turn and time to stop leaning before the vehicle stops turning. The time required to control the leaning angle before and after the turn may, in some situation, reduce the agility and the safety. A loss of traction while the vehicle is leaning and taking a turn may also be problematic because the lost of traction may suddenly remove the centrifugal forces counteracting the gravitational forces applied on the center of mass of the vehicle and cause a fall. The maximum speed at which a tilting vehicle 500 can take a turn may also be limited by the maximum tilt angle allowed before the vehicle or the passenger touch the ground. The use of the inertial compensation method to reduce the lean angle required to counteract the centrifugal forces may increase the maximum steering angle possible at a given speed and reduce the time required to control the inclination while taking a turn.

The proposed inertial compensation method may use one or more flywheel assembly 100 with its axis of rotation oriented at least in part in the lateral axis of the vehicle. The axis of rotation of the flywheel assembly 100 used in that method may rotate at least in part in the yaw axis with the vehicle's rotation when the vehicle is taking a turn to apply the precession torque counteracting at least in part the corresponding centrifugal forces. In this method, a total angular momentum in the backward direction may be stored in the one or more flywheel assembly 100 to generate a precession torque in the roll axis compensating at least in part for the centrifugal force's roll torque when the vehicle is taking a turn.

When the vehicle is taking a turn, the roll torque compensating at least in part for the centrifugal forces may be produced by the flywheel assembly 100 spinning backward because the angular momentum in it may produce a precession torque in the roll axis toward the inside of the turn when the vehicle and its flywheel assembly 100 rotate in the yaw axis. The proposed inertial compensation method may compensate at least in part for the centrifugal forces present while taking a turn with the precession torque in the roll axis produced by the rotation of the vehicle's flywheel's axle 105 in the yaw axis when the vehicle is taking a turn while moving in the forward direction.

In an embodiment, the method of using and installing a kit can include a step of providing a tilting vehicle 500; a step of providing an inertial compensation apparatus; a step of equipping the tilting vehicle with the provided inertial compensation apparatus so that stability enhancement is provided when in operation; a step of boarding the tilting vehicle; a step of accelerating the vehicle;

In an embodiment, the method of providing the inertial compensation may include the steps: 1) reading the vehicle speed sensor 2) determining the angular momentum required 3) reading the flywheel speed sensor 807 4) modulating respectively positively or negatively the rotational speed of each flywheel assembly 100 with the angular momentum controller 880: repeating the previous steps

The proposed inertial compensation method may also include the adjustment of the total angular momentum in the backward direction stored in the one or more flywheel assembly 100 with an angular momentum controller 880 compensating at least in part the increased centrifugal force's roll torque 900 present when the vehicle is turning while traveling at higher speed with an increased angular momentum in the backward direction.

In one embodiment, the flywheel assembly 100 used to apply this method may be attached to the vehicle and its axis of rotation may be oriented substantially laterally to provide a means to use the inertial compensation method.

One embodiment may also increase the total angular momentum in the backward direction stored in the flywheel assembly 100 when the speed of the vehicle increases to compensate, at least in part, for the increased centrifugal forces (e.g., roll torque) generated when taking a turn.

One embodiment may use a flywheel assembly 100 spinning forward and another flywheel assembly 100 spinning backward to control the total angular momentum in the backward direction.

In an embodiment, to increase the total angular momentum in the backward direction, the angular momentum controller 880 may slow down the flywheel assembly 100 spinning in the forward direction. As done with typical hybrid or electric vehicles, the electric motor spinning the flywheel assembly 100 may be used to transfer and receive energy stored as kinetic energy in the flywheel's rotating mass 118 and control the total angular momentum in the backward direction.

In one embodiment, the total angular momentum in the backward direction may be increased based on the measured forward speed of the vehicle by increasing the rotational velocity of the flywheel assembly 100 spinning backward.

In one embodiment, the total angular momentum in the backward direction may be adjusted based on the vehicle speed sensor's 808. In an embodiment, an angular momentum controller 880 may adjust the speed of the flywheel rotating mass 118 to apply the proposed inertial compensation method.

Some embodiments may transfer energy between the drive train assembly 512, the vehicle's battery 513 and the flywheel assembly 100 to control the total angular momentum in the backward direction stored in the flywheel assembly 100.

The proposed inertial compensation method may use a flywheel assembly 100 mechanically rotatably linked with the rotation of the propulsion motor or a wheel to ensure the flywheel's angular momentum increases proportionally with the vehicle's speed.

The inertial compensation method may be used in vehicle using skis, steered floats, rudders or similar devices to steer the trajectory of the vehicle.

The inertial compensation method may be used on boats, snowmobiles, personal watercrafts and other types of vehicles to improve their dynamic stability.

### Operation of the Inertial Compensation Method

The proposed inertial compensation method may be operated as a regular vehicle but with improved dynamic characteristics and improved power characteristics like regenerative braking and maximum peak power output.

### The Dynamics Enhancement Methods

The dynamics enhancement method combines steering enhancement method and the inertial compensation method to combine the advantages of each and may share the components used by one another.

A tilting vehicle 500 may be equipped with flywheel assembly 100 oriented and spinning in the proper direction and speed to be used for the application of steering enhancement method and for the application of the inertial compensation method simultaneously. One or more flywheel assembly 100 may be steered by the flywheel's gimbal 112 to be used for the application of the steering enhancement method while being used to control the total angular momentum in the backward direction for the application of the inertial compensation method. This may enable the dynamics enhancement methods to apply the balancing forces and to reduce the lean angle necessary to take a turn at the same time. Therefore, the dynamics enhancement methods may provide an increased agility, stability and control with the combination of the steering enhancement method and the inertial compensation method while using at least one flywheel assembly 100 in combination for the two methods.

A flywheel assembly 100 used to apply the steering enhancement method may be used or not at the same time to apply the inertial compensation method. A flywheel assembly 100 may be used to apply the inertial compensation method but without necessarily be used for the steering enhancement method. The proposed dynamics enhancement methods may enable someone skilled in the art of vehicle dynamics to determine the amount of flywheel assembly 100, the angular momentum stored in the flywheel assembly 100 and the use of it based on the vehicle design, the required stability, the required agility and level of control desired.

One proposed embodiment may apply the dynamics enhancement methods with more than one flywheel assembly 100 spinning in substantially opposite direction when the vehicle travel at low speed to lower at least in part the total angular momentum in the backward direction.

Some embodiments may also reduce the angular momentum of the flywheel assembly 100 spinning in the forward direction when vehicles travel at higher speed to increase at least in part the total angular momentum in the backward direction and decrease the required lean angle.

Some embodiments may also steer the flywheel's gimbal 112 of the flywheel assembly 100 as proposed with the steering enhancement method to apply a roll torque on the tilting vehicle 500. In an embodiment, the steering controller 850 may use the measured speed of the vehicle and the angular momentum controller 880 to adjust the speed of each flywheel assembly 100 to produce the total angular momentum in the backward direction required to use the inertial compensation method.

Some embodiments may also determine the angular momentum in the steered flywheel assembly 100 to adjust the linearization gain applied on the steering controller's 850 assistance.

Some embodiments may adjust the centering assistance 882 to compensate for the tilt angle error 885 corresponding to the precession torque in the roll axis based on the total angular momentum in the backward direction stored in the flywheel assembly 100, the vehicle speed, the vehicle's mass and the corresponding reduced lean angle.

In one embodiments of the invention, the method of providing the dynamics enhancement may include the steps of: providing a tilting vehicle with the dynamics enhancement apparatus, driving the vehicle, initiating a turn by manually applying a steering force (e.g., in the direction opposed to the intended trajectory); measuring/detecting the manually applied steering command; measuring extern forces applied on the tilting vehicle; determining a tilt angle error; determining a stability enhancement command; determining a steering command based on the determined stability enhancement command and the measured manually applied steering command; steering the steerable components (e.g., flywheel gimbal) of the inertial compensation apparatus to engage the tilting vehicle in the intended trajectory with at least one of a steering assistance and a stability assistance, reading the vehicle's speed sensor, determining a corresponding angular momentum for each flywheels, adjusting the angular momentum of the flywheels with the angular momentum controller 880; repeating the previous steps

### Description of the Embodiments

FIG. 1 in a front perspective view, illustrates an embodiment of a bicycle that may be used to apply the steering enhancement method or apparatus, the inertial compensation method or apparatus, and/or the two methods and/or the two apparatus in combination, referred to as the dynamics enhancement method or apparatus.

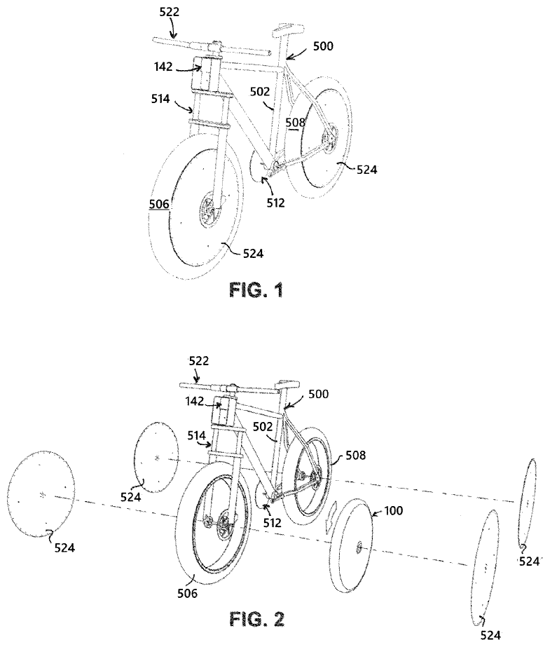

Now referring to FIG. 2 that shows a schematic representation of an embodiment of a typical electric bicycle, which may be used as the tilting vehicle 500 equipped with the system required to apply the steering enhancement method.

As seen in FIG. 6, in some embodiments, the control box 140 can contain the steering motor 142 of the steering controller 850 attached to the bicycle's head tube to steer the front fork 514. The steering controller 850 can use a steering motor 142 with its rotary output shaft 144 that may be connected with a belt and a pulley to the fork 514 to steer the fork 514.

In an embodiment, the fork 514 may be used as the steering linkage 816 to interconnect the steering of the trajectory controller 705 with the steering of the flywheel assembly 100 located inside the front wheel. The bicycle fork may also act as the flywheel's gimbal 112 changing the orientation of the flywheel's axle 105 to apply a precession torque in the roll axis of the tilting vehicle 500.

In an embodiment, the bicycle stem may be equipped with a steering torque sensor 953 and considered as a part of the steering controller 850. It will be understood by a person skilled in the art that the use of a typical strain gauge or other torque measuring device may be used to provide the mechanical components with measuring functions.

In one embodiment, the manually operated steering input 522 is also considered to be part of the steering controller 850.

The manually operated steering input 522 may be equipped with a steering torque sensor 953. The driver's steering torque 857 that can be applied by the driver 855 on the manually operated steering input 522 may be measured by the steering torque sensor 953. The steering controller 850 can use the steering torque sensor's 953 measurements to determine its contribution to the steering controller's 850 assistance.

In an embodiment, the control box 140 may contain a part of the steering controller's 850 components and also contain the stability enhancement controller 809 and its components. The control box 140 may also contain a steering position sensor 954 connected to measure the steering angle of the steered assembly 899. The steering controller 850 may use magnets on the side of the wheel and a hall sensor on the front fork 514 measuring the rotation of the magnet as a means for the vehicle speed sensor's 808 to determine the speed of the vehicle. The steering controller 850 may use a multi-turn encoder on the steering motor 142 as a means for the steering position sensor 954 to detect the steering angle.

An embodiment may use two wheel facing covers 524 to rotatably connect the rear wheel 508 on the rear wheel's axle of the bicycle. In some embodiments, the rear wheel 508 may not contain any flywheel assembly 100.

An embodiment may use two wheel facing covers 524 rotatably connecting the front wheel 506 on the front flywheel's axle 105 of the bicycle. In an embodiment, the front flywheel's axle 105 may be connected to the fork 514. The flywheel's axle 105 may be a component of the flywheel assembly 100 located inside the front wheel 506 and between the two facing cover 524. The flywheel's rotating mass 118 may normally spin in the forward direction. The flywheel's rotating mass 118 may rotate freely relative to the front wheel 506.

It is to be understood that a preferred approach may be used to determine the flywheel's speed by using the flywheel's motor as the flywheel's speed sensor 807. This may include the measurement of back EMFs (electromotive force), commutation frequency or high frequency injection to determine the rotor's speed or position. It is also to be understood that typical sensor such as a Hall motor encoder may be an integral part of the flywheel's motor and may be used as the flywheel's speed sensor 807. All of these methods and components can be replaced by any suitable alternative known by experts in motor design.

As visible in FIG. 5, the flywheel assembly 100 may contain a flywheel's axle 105 with bearing 108 attached to bearing holder 109. The bearing holder 109 may rotatably attach the flywheel's rotating mass 118 and the flywheel's rotor 106 on the flywheel's axle 105. The flywheel's stator 104 may be fixed on the flywheel's axle 105 and apply the electromagnetic forces rotating the flywheel's rotor 106 and the flywheel's rotating mass 118.

The electric bicycle may provide the electrical power from its battery to the stability enhancement controller 809, the flywheel assembly 100 and the stability enhancement controller 809.

A drive train assembly 512 may be mounted on the vehicle chassis 502 to drive the rear wheel 508. The drive train assembly may be a typical mid drive electric motor combined with pedal power.

As explained in the description of the stability enhancement method and as seen in the FIG. 7, the steering controller 850 may supplement the driver steering 855 with a steering actuator's 818 assistance that may also be configured to include other assistance (e.g., a stability enhancement steering 810, a centering assistance, a steering damper assistance and a traction assistance).

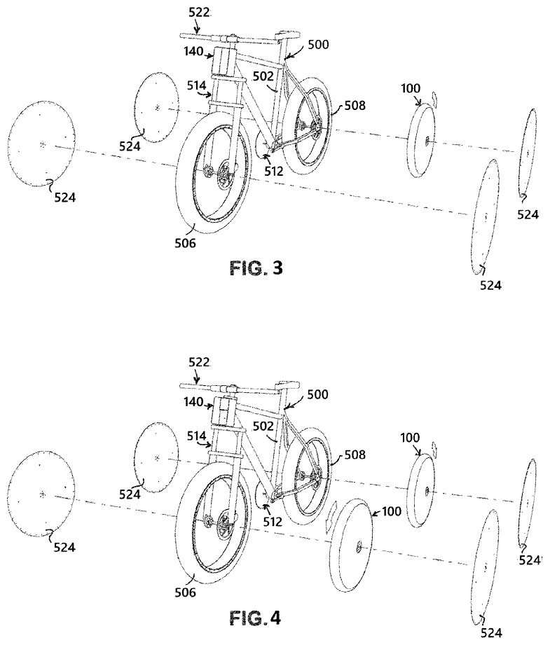

Now referring to FIG. 3 that illustrates yet another embodiment of a typical electric bicycle, which may be used as the roll unstable wheeled vehicle 600 equipped with the system required to apply the inertial compensation method.

An embodiment may use two wheel facing covers 524 to rotatably connect the front wheel 506 on the wheel axle of the front fork 514. In an embodiment, the front wheel may not contain any flywheel assembly 100.

An embodiment may use two wheel facing covers 524 to rotatably connect the rear wheel 508 on the rear flywheel's axle 105 of the bicycle. In an embodiment, the rear flywheel's axle 105 may be attached to the vehicle chassis 502. The flywheel's axle 105 may be a component of the flywheel assembly 100 located inside the rear wheel 508 and between the two facing cover 524. The flywheel's rotating mass 118 may spin in the backward direction. The flywheel's rotating mass 118 may rotate freely relative to the rear wheel 506.

The angular momentum controller 880 may be located in the control box 140. The angular momentum controller 880 may adjust the total angular momentum in the backward direction by adjusting the angular velocity of the flywheel's rotating mass 118 in the rear wheel. The angular momentum controller 880 may be electrically connected to the electric bicycle's battery 513. The angular momentum controller 880 may use magnets on the facing cover 524 and a hall sensor as a means for the vehicle speed sensor's 808 to detect the speed of the vehicle. The inertial compensation method may use the steering controller 850 with some of the functions used in the embodiment of FIG. 2 but without the precession torque from the steering of the front flywheel when no flywheel assembly 100 is installed in the front wheel.

In an embodiment, the steering controller 850 may contain the angular momentum controller 880 to adjusting the total angular momentum in the backward direction and reduce the lean angle required to take a turn.

The driver may operate an embodiment as a regular electric bicycle but with a reduced lean angle when taking a turn.

The driver may program or adjust the total angular momentum in the backward direction automatically applied by the angular momentum controller 880 based on the vehicle speed sensor's 808.

FIG. 4 illustrates another embodiment that may combine features of the embodiment shown in FIG. 2 and FIG. 3 to enable an electric bicycle with the application of the steering enhancement method, the inertial compensation method or the dynamics enhancement methods.

In an embodiment, the control box 140 may contain the steering controller's 850 with the components for the stability enhancement controller 809 and its angular momentum controller 880. These components may be in operative communication with one another.

Signals from many sensors described to apply the steering enhancement method and the inertial compensation method may be shared by the steering controller 850.

An embodiment may use the same steering assembly 815 as the embodiment of FIG. 2 and the same rear wheel and rear flywheel assembly as the embodiment of FIG. 3.

In an embodiment, the angular momentum controller 880 of the steering controller 850 may adjust the total angular momentum in the backward direction when the speed of the vehicle increases to improve the dynamic stability and reduce the leaning angle. The angular momentum controller 880 may also ensure that enough angular momentum spinning in the forward direction is stored in the front flywheel 100 to allow the desired level of precession from the stability enhancement method.

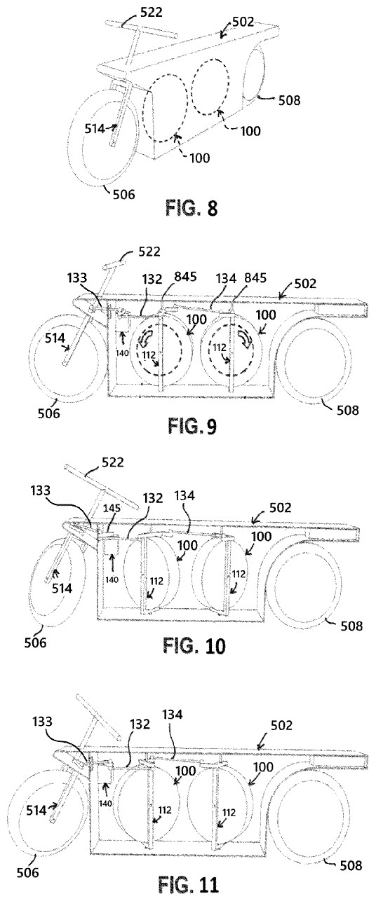

Now referring to FIGS. 8 to 11 that illustrates embodiments that can combine features that may be used for the application of the steering enhancement method, the inertial compensation method or the dynamics enhancement methods in alternative embodiments of the tilting vehicle (e.g., a motorcycle). These embodiments show that various similar or alternative embodiments can present other means to provide the dynamics enhancements methods with the required functions for its application and can comprise various types of enhancement apparatus.

An embodiment may use a steering assembly 815 containing two flywheel assemblies 100 located inside the vehicle chassis 502. Each flywheel assembly 100 may be located inside a flywheel's gimbal 112. The front flywheel assembly 100 may normally rotate forward and the rear flywheel assembly 100 may normally rotate backward. The flywheel assembly 100 and the flywheel's gimbal 112 may be normally oriented to apply a precession torque in the roll axis of the motorcycle when the steering assembly 815 is steered.

The two flywheel's gimbal 112 may be steered in the opposite direction by a counter-rotating gimbal steering linkage 134 and may be mutually centered. A steering motor 142 may be located in the control box 140. The rotary output shaft of the steering motor 142 may be protruding outside the center of the top of the control box 140 to actuate a steering motor arm 145. Therefore, one end of the steering motor arm 145 can be attached to the steering motor's 142 shaft and the second end of the steering motor arm 145 may be pivotally connected to a motor steering linkage 132. The control box 140 may be connected to the vehicle chassis 502. The motor steering linkage 132 may interconnect the steered position of the steering motor 142 with the steered position of the flywheel's gimbal 112.

The front steering linkage 133 may transfer the steering between the steering motor arm 145 and the front fork 514 and may be mutually centered.

In some embodiments, a driver 855 may use the manually operated steering input 522 to steer and balance the vehicle. The manually operated steering input 522 may be equipped with a steering torque sensor 953 sending signal to the rest of the steering controller 850.

In some embodiments, the motor steering linkage 132, the front steering linkage 133 and the counter-rotating gimbal steering linkage 134 may act as one steering linkage 816 to simultaneously steering the trajectory controller 705 and steering of the flywheel's gimbal (e.g., by means of a rigid connection between components). The steering linkage 816 may ensure that the roll torque from the steering of the multiple components can contribute to one another by being in the same direction and in the direction opposite to the steered trajectory. The multiple steering linkage 816 may also transmit a steering torque from the flywheel's gimbals 112 steering the trajectory controller 705 away from the roll torque applied on the tilting assembly.

In an embodiment, it is to be noted that the trajectory controller 705 is the front wheel 506.

An embodiment may also be equipped with flywheel assembly 100 installed inside the front wheel 506 and the rear wheel 508 similarly to the one of FIG. 4.

Some embodiments may be used with ski or float instead of the actual wheels while maintaining the ability to apply the dynamics enhancement methods, the steering enhancement method or the inertial compensation method.

Some embodiments (e.g., an embodiment using ski or floats) may be operated as a regular motorcycle but with the added control over the agility and stability.

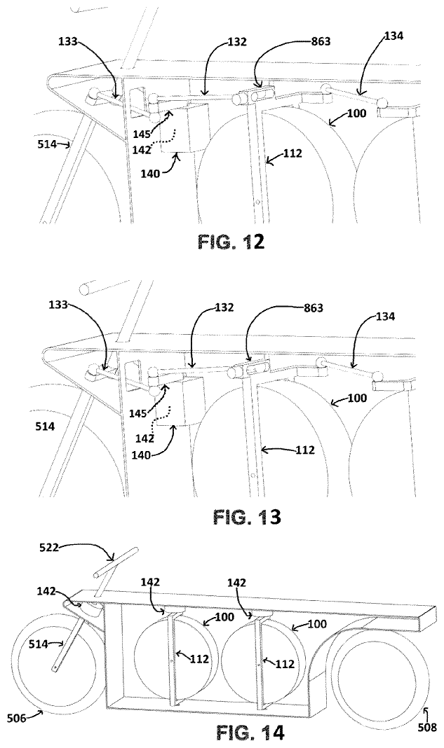

As illustrated in FIGS. 12 and 13, the embodiment from FIGS. 8 to 11 may be equipped with a gimbal's ratio adjustment 863. This gimbal's ratio adjustment 863 may be equipped with a steering ratio actuator changing the effective length of the torque arm of the flywheel's gimbal 112. The gimbal's ratio adjustment 863 may be pivotably connected to one extremity of the motor steering linkage 132 and to the side of the flywheel's gimbal 112. This may enable the flywheel's gimbal 112 to be rigidly steered with the rest of the steering assembly 815 while benefiting of an adjustable steering ratio. The gimbal's ratio adjustment 863 may reduce the distance between the extremity of the motor steering linkage 132 and the gimbal's axis 845 to increase steering ratio of the flywheel's gimbal 112 or increase this distance to reduce it.

FIG. 14 shows a side perspective view illustrating an embodiment with a system to apply the dynamics enhancement methods, including multiple steering motors 142 as the steering actuator 818 and as the steering linkage 132 to steer the flywheel's gimbal 112 mounted in the chassis of a motorcycle, the manually operated steering input 522 and the steered wheels 506.

In some special conditions like collision and loss of traction, the use of multiple steering motor may temporarily enable the use of the independent steering (e.g., coordinated steering) of the flywheel's gimbal 112 relative to the other components of the steering assembly to apply a precession torque in the roll axis without affecting the steering of the trajectory controller 705. It is to be understood that the system may automatically return the simultaneous steering of these components once the special condition return to normal.

The steering controller 850 may use the actuator of the gimbal's ratio adjustment 863 to automatically increase the steering ratio or to reduce it based on the configured driver's preference, the speed of the vehicle and other vehicle's parameter. In an embodiment, the gimbal steering ratio may be increased when the vehicle is traveling at low speed to increase the roll torque applied to balance when the vehicle is steered while traveling at low speed or standstill. In an embodiment, the steering controller 850 may increase the linearization gain 881 applied on the steering controller assistance 892 and can increase the flywheel's gimbal 112 steering ratio when traveling at low speed to make the vehicle more stable, easy to operate and/or comfortable.

The actuator of the gimbal's ratio adjustment 863 may be a lead screw, a rack and pinion, a hydraulic pump, interconnected servomotors or any other known mean to adjust the ratio (e.g., the effective length of a torque arm) between two rotary motions. In yet another embodiment, the motorcycle of FIG. 8 may be equipped with multiple steering motor 142 to link and steer the position of the components of the steered assembly 899. The use of multiple steering motor 142 as the mechanical steering linkage 816 between the components may preserve the ability to apply the steering enhancement method, the inertial compensation method and the dynamics enhancement methods. The synchronization of the multiple steering motor 142 and the high-power requirements necessary to achieve a rigid linkage of the components of the steering assembly 815 may be possible, for example, with proper tuning and sizing of the linked steering motor 142.

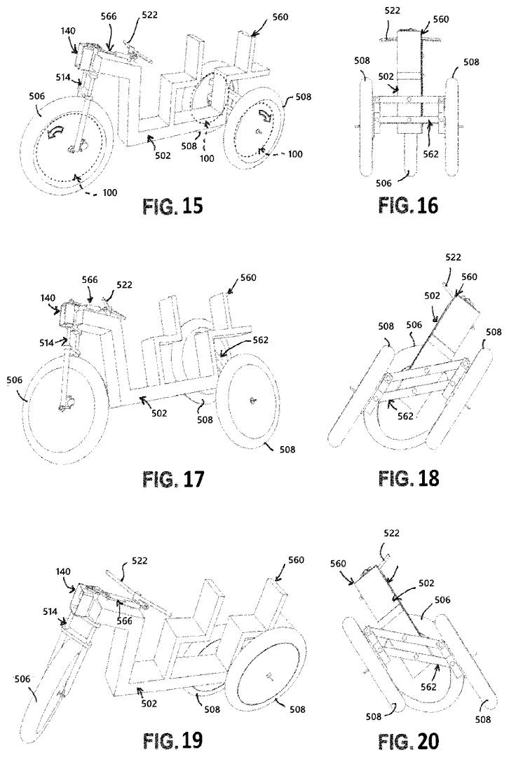

Referring to FIGS. 15 to 23 inclusively, in another embodiment of the invention, a system may be mounted on a three-wheel motorcycle 560 to enable it with the application of the dynamics enhancements methods, the stability enhancement method or the inertial compensation method. The three-wheel motorcycle 560 may include a pair of rear wheels 508 mounted on a tilt mechanism 562 connected to the rear end of the vehicle chassis 502. The three-wheel motorcycle 560 may be used as a tilting vehicle 500.

Each wheel of the pair of rear wheels 508 mounted on the tilt mechanism 562 may contain a flywheel assembly 100 located at the center of it and normally rotating in the backward direction. The tilt mechanism 562 may be suitably configured so as to tilt the rear wheels 508 parallel to the chassis 502 as the three-wheel motorcycle 560 tilt relative to the ground and with the rear wheels in contact with the ground. The motion of the tilt mechanism 562 is visible in the FIGS. 16, 18 and 20.

The three-wheel motorcycle 560 may include a steering assembly 815 containing of a front fork 514., a front wheel 506 and a flywheel assembly 100 located inside the front wheel 506 and normally rotating in the forward direction.

In an embodiment, the front wheel 506 may act as the trajectory controller 705 and the front fork 514 as the flywheel's gimbal 112.

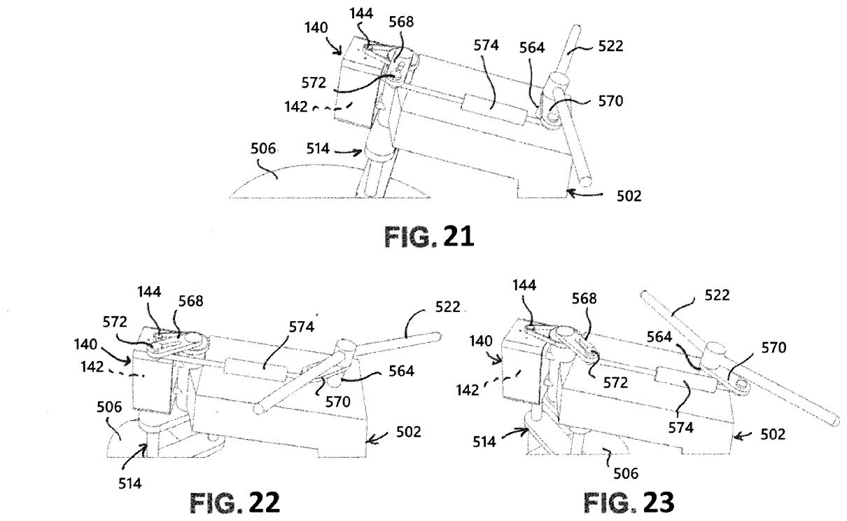

As illustrated in the enlarged views of FIGS. 21, 22 and 23, the manually operated steering input 522 of the three-wheel motorcycle 560 may be mounted on a steering handle axle 564 pivotally mounted on the vehicle chassis 502 to enable the driver to steer the front fork 514 while sitting.

In an embodiment, the driver 855 may be provided with a flexible steering input 574 from the steering controller 850. The flexible steering input 574 may link the steering of the manually operated steering input 522 with the steering of the front fork 514.

The flexible steering input 574 may be suitably configured for transmitting the steering movement applied on the manually operated steering input 522 to the front fork 514 with at least a slight linear flexibility there between. The linear flexibility of the flexible steering input 574 may be provided by a gas in a pneumatic cylinder, an elastomer, a coil spring or any other component able to deform itself and take back its original shape when the force is applied is removed. The flexibility of the flexible steering input 574 may be adjusted by the driver 855. The use of a pneumatic cylinder spring with an adjustable pressure may provide the driver with a means to adjust the flexibility of the flexible steering input 574.

In an embodiment, the flexible steering input 574 may include a first end pivotally connected to an adjustable fork leaver 568 extending laterally from the vehicle front fork 514. The adjustable fork leaver 568 may be configured for allowing the user to selectively adjust the driver's ratio adjustment 861 between the manually operated steering input 522 and the front fork 514. The second end of the flexible steering input 574 may be pivotally connected to a steering handle lever 570 extending laterally from the steering handle axle 564. The driver's ratio adjustment may be illustrated as a sliding nut adjustment 572 within an elongated slot along the adjustable fork lever 568. It is to be understood that other known means may be used to provide the driver with a driver's ratio adjustment.

What is claimed is:

1. A steering enhancement apparatus connectable to a tilting vehicle to provide improved steering and stability, the steering enhancement apparatus comprising:
a steering controller comprising:
at least one driver input for receiving a driver's steering command;
at least one tilt angle error sensor;
a stability enhancement controller for determining a stability enhancement steering command to reduce a tilt angle error determined based on signals of said at least one tilt angle error sensor;
at least one steering actuator connectable to a trajectory controller of said tilting vehicle for the application of an actuator steering force on said trajectory controller based on a force steering controller's assistance command; and
wherein said force steering controller's assistance command is determined based at least on the received said driver's steering command and on said stability enhancement steering command;
at least one flywheel assembly comprising:
a flywheel rotating mass spinning when said steering enhancement apparatus is in operation; and
a motor for providing part of a total angular momentum of said flywheel by spinning said at least one flywheel;
at least one of:
a coupling interface for mounting said at least one flywheel assembly onto said trajectory controller so that steering of said trajectory controller to a first steered position simultaneously steers said at least one flywheel assembly to said first steered position; and
at least one steering linkage connectable to said trajectory controller and connected to at least one flywheel gimbal assembly so that said steering of said trajectory controller to said first steered position simultaneously steers said at least one flywheel gimbal assembly to a corresponding second steered position following a predetermined steering ratio, wherein said at least one flywheel's gimbal comprises:
at least one gimbal's axis pivotally connectable to a tilting assembly of the said tilting vehicle to be substantially perpendicular to a longitudinal axis of said tilting assembly, and
wherein an axis of rotation of said at least one flywheel assembly is pivotally connected substantially perpendicularly to said gimbal's axis,
wherein, when said steering enhancement apparatus is connected to said tilting vehicle, the steering of said trajectory controller of said tilting vehicle applies a precession roll torque from said at least one flywheel assembly at least in part toward a right side of said tilting vehicle when the steering rate is toward a left side of said tilting vehicle and a precession roll torque at least in part toward the left side when the steering rate is toward said right side.

2. The steering enhancement apparatus as defined in claim 1, wherein said driver's steering command is provided from at least one of:
a steering force sensor measuring a driver's steering force applied by the driver to steer said tilting vehicle; and
an autonomous driving system generating said driver's steering command.

3. The steering enhancement apparatus as defined in claim 1, wherein said driver's steering command is provided from at least one of:
a transmitter transmitting said driver's steering command detected by a driver interface and generated by said driver; and
an autonomous driving system generating said driver's steering command.

4. The steering enhancement apparatus as defined in any one of claims 1 to 3, wherein said steering linkage is a mechanical steering linkage.

5. The steering enhancement apparatus as defined in any one of claims 1 to 3, wherein said at least one steering actuator at least comprises a first steering actuator for steering said trajectory controller to said first steered position and a second steering actuator for steering said at least one flywheel's gimbal to said second steered position, wherein said first and second steering actuator acts as said steering linkage to interconnect the first steered position and the second steered position following said a predetermined steering ratio.

6. The steering enhancement apparatus as defined in any one of claims 1 to 5, wherein said first steered position and said second steered position is the orientation of said one or more flywheel assembly is substantially centered when said tilting vehicle initiates a forward motion.

7. The steering enhancement apparatus as defined in claim any one of claims 1 to 6, wherein said steering controller further comprises a steering position sensor for measuring a steering position, wherein said steering controller further determines a centering assistance command to steer away from a centered position based on a measured said steering position and further considers said centering assistance to determine said steering controller's assistance command.

8. The steering enhancement apparatus as defined in any one of claims 1 to 7, wherein said steering controller add a traction assistance to said steering controller's assistance command based on lateral slippage estimation.

9. The steering enhancement apparatus as defined in any one of claims 1 to 8, wherein said steering controller determines a steering damper assistance reducing a speed and acceleration of said steering actuator as a speed of the tilting vehicle increases.

10. The steering enhancement apparatus as defined in any one of claims 1 to 6, wherein said steering controller determines a linearization gain based at least in part said speed of said tilting vehicle, a total angular momentum in a backward direction of said flywheel rotating mass, an angular momentum in the steered flywheels assembly and a position of the steered assembly.

11. The steering enhancement apparatus as defined in any one of claims 1 to 10, wherein said tilting vehicle is operable as a torque controlled trajectory steering in the direction opposite to the applied torque and wherein said trajectory controller provides a position feedback to said driver.

12. The steering enhancement apparatus as defined in any one of claims 1 to 11, wherein said steering controller mechanically transmits the driver's steering force to the trajectory controller through the steering actuator to provide a mechanical path enabling the driver to steer the vehicle in case of failure.

13. The steering enhancement apparatus as defined in any one of claims 1 to 12, wherein said connectable steering enhancement apparatus is a steering enhancement kit connectable to said tilting vehicle.

14. The steering enhancement apparatus as defined in claim 13, wherein said steering enhancement kit is connectable to a steering

15. The steering enhancement apparatus as defined in any one of claims 1 to 14, wherein said autonomous driving system comprises a collision avoidance function used to determine said driver's steering command based on proximity data provided from at least one proximity sensor.

16. The steering enhancement apparatus as defined in any one claims 1 to 15, wherein said at least one driver input receives said driver's steering command from said autonomous driving system, from said steering force sensor and said transmitter, wherein said steering controller determines said steering controller's assistance command based on one of said received driver's steering commands.

17. The steering enhancement apparatus as defined in claim 16, wherein said steering controller determines said steering controller's assistance command based on a prioritized one of said received driver's steering commands following a priority rule.

18. The steering enhancement apparatus as defined in any one of claims 1 to 17, wherein said priority rule prioritize said driver's steering command from said autonomous driving system.

19. The steering enhancement apparatus as defined in any one of 1, 2 and 4 to 18, wherein said steering force sensor is connectable to a manually operated steering input through a flexible steering input providing flexibility between said manually operated steering input and said steering input.

20. The steering enhancement apparatus as defined in claim 19, wherein a flexibility of said flexible steering input is manually adjusted.

22. The steering enhancement apparatus as defined in claim 4 or 5, wherein a flexibility of said flexible steering input is automatically adjusted based at least in part on said speed of said tilting vehicle.

23. The steering enhancement apparatus as defined in any one of claims 1, 3 to 18, wherein transmitter is a manually operated steering input is a remote manually operated steering input electronically sending said manual driver's steering command to said steering input of said steering controller, wherein said steering controller further determines said feedback command at least based on at least one of said first steered position and said second steered position; and electronically sends said feedback command to said manually operated steering input.

24. The steering enhancement apparatus as defined in any one of claims 1 to 23, wherein said steering controller is connectable to a vehicle speed sensor for measuring said speed of said tilting vehicle.

25. The steering enhancement apparatus as defined in any one of claims 1 to 24, wherein said steering controller further comprises a control interface allowing a user to selectively adjust a degree of stabilization assistance provided by said controller.

26. The steering enhancement apparatus as defined in claim 25, wherein said control interface can be used to limit said steering controller assistance command to be based on only one of said manual driver's steering command and said stability enhancement steering command.

27. The steering enhancement apparatus as defined in any one of claims 1 to 26, wherein said steering controller further considers said speed of said tilting vehicle to determine said steering controller assistance command.

28. The steering enhancement apparatus as define in any one of claims 1 to 27, wherein said steering linkage further comprises a steering ratio adjusting component for adjusting said predetermined steering ratio.

29. The steering enhancement apparatus as defined in claim 28, wherein said steering ratio adjusting component comprises a steering ratio actuator for automatically adjusting said predetermined steering ratio following a ratio adjustment command.

30. The steering enhancement apparatus as defined in any one of claims 1 to 29, wherein said controller further considers a speed, a weight and an angular momentum of said at least one flywheel to determine said steering controller assistance command.

31. The steering enhancement apparatus as defined in any one of claims 1 to 30, wherein said steering controller further comprises at least one flywheel speed sensor for measuring said speed of said flywheel of said at least one flywheel assembly, wherein said controller further considers said speed to determine said steering controller assistance command.

32. The steering enhancement apparatus as defined in any one of claims 1 to 31, further comprising a pendulum connectable to said tilting assembly of said tilting vehicle, and wherein said at least one tilt angle error sensor comprises an angle sensor for measuring the angle between said pendulum and said tilting assembly.

33. The steering enhancement apparatus as defined in any one of claims 1 to 32, wherein said at least one tilt angle error sensor comprises a lateral acceleration sensor for measuring at least one lateral force on said tilting vehicle and a roll rate sensor for measuring a roll acceleration of said tilting vehicle, wherein said tilt angle error is determined based on said at least one measured lateral force and said roll acceleration.

34. The steering enhancement apparatus as defined in any one of claims 1 to 33, wherein said steering controller determines said steering controller assistance command further based on a centering assistance for centering said trajectory controller around a desired trajectory.

35. The steering enhancement apparatus as defined in any one of claims 1 to 34, wherein said steering controller is connectable to a drive train assembly of said tilting vehicle, wherein said steering controller further determines a drive train control command for driving said drive train to apply a drive force for displacing a contact point of said trajectory controller relatively to a support surface of said tilting vehicle, when said first steered position is off centered, so that said drive train assembly applies a roll torque on a center of mass of said tilting vehicle according to said drive command; and wherein said drive train control command is determined based on said tilt angle error and an orientation of said first steered position.

36. The steering enhancement apparatus as defined in any one of claims 1 to 35, wherein said steering enhancement apparatus when connected to said tilting vehicle is steerable as a position controlled trajectory controller by applying a torque controlled steering in a direction opposed to a manual torque by said driver applied thru said flexible steering input.

37. The steering enhancement apparatus as defined in any one of claims 1 to 36, wherein said steering controller determines a steering damper assistance reducing a speed and an acceleration of said steering actuator as a speed of said tilting vehicle increases.

38. The steering enhancement apparatus as defined in any one of claims 1 to 37, wherein energy is stored as kinetic energy by increasing said speed of said flywheel of said at least one flywheel assembly using said motor of said at least one flywheel assembly.

39. The steering enhancement apparatus as defined in claim 38, further comprising a propulsion motor for propelling said tilting vehicle, wherein part of a kinetic energy of said tilting vehicle is captured by said propulsion motor and transferred as electric current to said motor of said at least one flywheel assembly to be stored as said stored kinetic energy, and wherein said stored kinetic energy is captured by said motor of said at least one flywheel assembly and transferred as said electric current to said propulsion motor for propelling said tilting vehicle.

40. The steering enhancement apparatus as defined in claim 39, wherein said tilting vehicle further comprises a battery, and wherein said electric current is exchanged with said battery.

41. The steering enhancement apparatus as defined in any one of claims 1 to 40, wherein said at least one flywheel gimbal assembly comprises a first flywheel gimbal assembly and a second flywheel gimbal assembly, wherein said flywheel of said first flywheel gimbal assembly spins frontward and said flywheel of said second flywheel gimbal assembly spins backward, and wherein a total angular momentum of said flywheel of said first and said second flywheel gimbal assembly ensures that said roll torque applied on said tilting assembly is oriented substantially toward said right side of said tilting assembly when said trajectory of said tilting vehicle is changing leftwardly and is oriented substantially toward said left side of said tilting assembly when said trajectory is changing rightwardly.

42. The steering enhancement apparatus as defined in claim 41, wherein said motor of said second flywheel gimbal assembly adjust said speed of said flywheel of said second flywheel gimbal assembly for increasing an angular momentum of said flywheel of said second flywheel gimbal assembly when said speed of said tilting vehicle increases and for reducing said angular momentum of said flywheel of said second flywheel gimbal assembly when said speed of said tilting vehicle decreases.

43. The steering enhancement apparatus as defined in claim 42, wherein said stored kinetic energy is stored in said flywheel of said second flywheel gimbal assembly as said angular momentum.

44. The steering enhancement apparatus as defined in any one of claims 1 to 43, wherein said a flywheel spinning mass of said flywheel is connected to said motor through a flexible flywheel linkage for reducing a transfer of vibrations between said flywheel mass and said motor.

45. The steering enhancement apparatus as defined in claim 44, wherein resonant frequency said flexible flywheel linkage is below a rotation frequency of said flywheel spinning mass in operation.

46. The steering enhancement apparatus as defined in any one of claims 1 to 45, wherein said flywheel assembly is coaxially mounted inside said trajectory controller.

47. The steering enhancement apparatus as defined in any one of claims 1 to 46, wherein said flywheel motor is coaxially mounted inside said flywheel assembly.

48. The steering enhancement apparatus as defined in any one of claims 1 to 47, wherein said tilting vehicle is a tilting wheeled vehicle and said trajectory controller is at least one steered wheel.

49. The steering enhancement apparatus as defined in any one of claims 1 to 48, wherein a closed loop displacement controller monitor the total the displacement produced by said drive train control command and assist said drive train control command to maintain the total the displacement produced around zero.

50. A inertial compensation apparatus connectable to a vehicle to provide improved vehicle dynamics, the inertial compensation apparatus comprising:
at least one flywheel assembly comprising:
a flywheel rotating mass spinning when said steering enhancement apparatus is in operation; and
a motor for providing part of a total angular momentum of said flywheel by spinning said at least one flywheel;
wherein said at least one flywheel assembly is connected to said vehicle to precess at least in part in the roll axis of the vehicle when the vehicle is taking a turn:
a vehicle speed sensor;
an angular momentum controller adjusting the total angular momentum in the backward direction in said at least one flywheel assembly at least in part based on the measurement from said vehicle speed sensor to compensate at least in part for the centrifugal forces present when the vehicle is taking a turn at the speed measured with said vehicle speed sensor.

51. The inertial compensation apparatus as defined in claim 50 comprising any one of claims 1 to 49:
Wherein the said flywheel assembly are used in the two apparatus at once.
